(19) United States
(12) Patent Application Publication
(10) Pub. No.: US 2026/0091581 A1
(43) Pub. Date: Apr. 2, 2026

(54) LIQUID EJECTION HEAD AND APPARATUS

(71) Applicant: RISO Technologies Corporation, Tokyo (JP)

(72) Inventor: Yasuhito KIJI, Mishima Shizuoka (JP)

(21) Appl. No.: 19/334,707

(22) Filed: Sep. 19, 2025

(30) Foreign Application Priority Data
Sep. 27, 2024 (JP) 2024-168069
Jul. 14, 2025 (JP) 2025-118624

(51) Int. Cl. B41J 2/045

(52) U.S. Cl. CPC B41J 2/04588; B41J 2/04508; B41J 2/0455; B41J 2/0457; B41J 2/04573; B41J 2/04581

(57) ABSTRACT

A liquid ejection head includes a nozzle, a pressure chamber storing liquid and communicating with the nozzle, a volume of the chamber being varied to eject the liquid from the nozzle, an actuator configured to vary the volume in response to a signal, and a drive circuit configured to generate the signal. The signal includes ejection waveforms, each including: expansion waveforms to expand the volume, and contraction waveforms to contract the volume. One of the expansion waveforms and one of the contraction waveforms cancel out vibrations of an acoustic resonance frequency higher than a main acoustic resonance frequency of the liquid in the chamber, and the vibrations are caused by a preceding expansion waveform followed by the one of the expansion waveforms and a preceding contraction waveforms followed by the one of the contraction waveforms.

### CROSS-REFERENCE TO RELATED APPLICATION

This application is based upon and claims the benefit of priority from Japanese Patent Application No. 2024-168069, filed on Sep. 27, 2024, and No. 2025-118624, filed on Jul. 14, 2025, the entire contents of which are incorporated herein by reference.

### FIELD

Embodiments described herein relate generally to a liquid ejection head and apparatus.

### BACKGROUND

In the related art, in a liquid ejection head that ejects liquid, a dot diameter formed when a droplet lands on a medium is increased by successively ejecting a plurality of droplets, thereby achieving gradation of ink density on the medium. However, when the main acoustic vibration frequencies of the pressure chambers vary, and the same drive waveform in which the ejection waveform widths of the first and last drops differ is applied to the pressure chambers, the successively ejected droplets may fail to merge, resulting in degraded printing quality.

### BRIEF DESCRIPTION OF THE DRAWINGS

FIG. 1 is a cross-sectional view showing a configuration of a liquid ejection head according to an embodiment.

FIG. 2 is a cross-sectional view showing the configuration of the liquid ejection head.

FIG. 3 is a block diagram schematically showing a configuration of a drive circuit.

FIG. 4 is a diagram showing a configuration of a liquid ejection device.

FIG. 5 is a block diagram showing an example of a configuration of the liquid ejection device.

FIG. 6 is a diagram showing an example of a drive waveform including an ejection waveform and a cancel waveform of a liquid ejection head according to a comparative example.

FIG. 7 is a diagram showing an example of a drive waveform and an acoustic vibration.

FIG. 8 is a diagram showing a relation between the drive waveform and an ejection droplet in an example.

FIGS. 9A, 9B, and 9C are diagrams showing an example of the ejection droplets.

FIG. 10 is a diagram showing an example of frequency analysis.

FIG. 11 is a diagram showing an example in which a main acoustic vibration and a parasitic vibration are synthesized.

FIG. 12 is a diagram showing an example of frequency analysis.

FIG. 13 is a diagram showing an example of a drive waveform and an acoustic vibration.

FIG. 14 is a diagram showing an example of the drive waveform and the acoustic vibration.

FIG. 15 is a diagram showing an example of the drive waveform.

FIG. 16 is a diagram showing an example of a drive waveform of a liquid ejection head according to another embodiment.

FIG. 17 is a diagram showing an example of the drive waveforms.

FIG. 18 is a diagram showing an example of the drive waveform.

FIG. 19 is a diagram showing a relation between a waveform width and an ejection force based on a condition of a time width Dp of a leading droplet and a subsequent droplet in an ejection waveform by which two droplets are ejected.

FIG. 20 is a diagram showing the relation between the waveform width and the ejection force.

FIG. 21 is a diagram showing the relation between the waveform width and the ejection force.

FIG. 22 is a diagram showing the relation between the waveform width and the ejection force.

FIG. 23 is a diagram showing the relation between the waveform width and the ejection force.

FIG. 24 is a diagram showing the relation between the waveform width and the ejection force.

FIG. 25 is a diagram showing the relation between the waveform width and the ejection force.

FIG. 26 is a diagram showing the relation between the waveform width and the ejection force.

FIG. 27 is a diagram showing the relation between the waveform width and the ejection force.

FIG. 28 is a diagram showing the relation between the waveform width and the ejection force.

FIG. 29 is a diagram showing the relation between the waveform width and the ejection force.

FIG. 30 is a diagram showing the relation between the waveform width and the ejection force.

FIG. 31 is a diagram showing the relation between the waveform width and the ejection force.

FIG. 32 is a diagram showing the relation between the waveform width and the ejection force.

FIG. 33 is a diagram showing an example of the drive waveform.

FIG. 34 is a diagram showing an example of a drive waveform according to another embodiment.

FIG. 35 is a diagram showing an example of the drive waveform.

### DETAILED DESCRIPTION

A liquid ejection head and apparatus are provided that can make an ejection force of each droplet substantially uniform and can increase an ejection speed of subsequent droplets.

In general, according to one embodiment, a liquid ejection head comprises: a nozzle plate including a nozzle; a pressure chamber that is capable of storing liquid and communicates with the nozzle, a volume of the pressure chamber being varied to eject the liquid from the nozzle; an actuator configured to vary the volume of the pressure chamber in response to a drive signal; and a drive circuit configured to generate the drive signal. The drive signal includes a plurality of ejection waveforms, each including: a plurality of expansion waveforms for applying voltages to expand the volume of the pressure chamber, and a plurality of contraction waveforms for applying voltages to contract the volume of the pressure chamber, and one of the expansion waveforms and one of the contraction waveforms respectively cancel out vibrations of an acoustic resonance frequency higher than a main acoustic resonance frequency of the liquid in the pressure chamber, the vibrations being caused by a preceding one of the expansion waveforms, which is followed by said one of the expansion waveforms, and a preceding one of the contraction waveforms, which is followed by said one of the contraction waveforms.

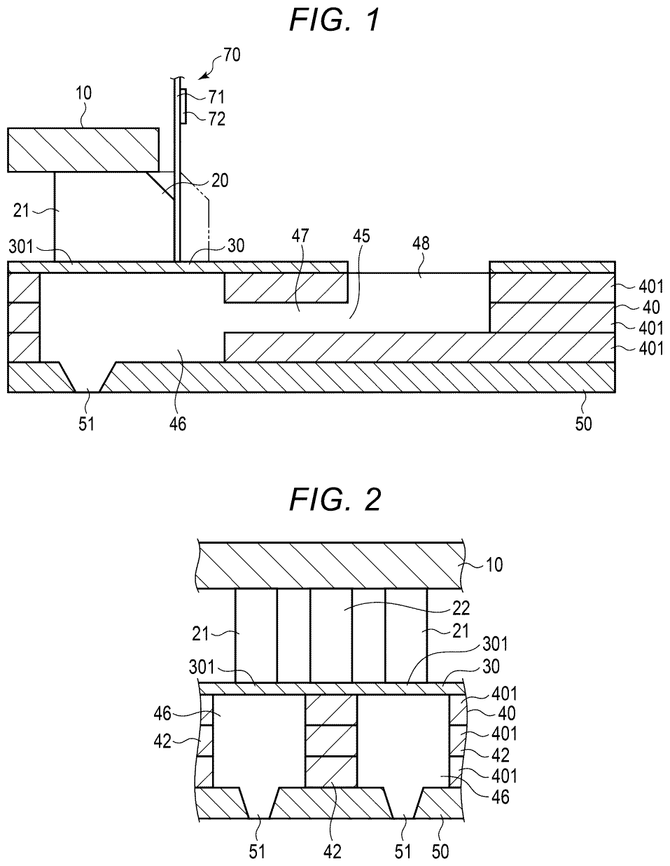

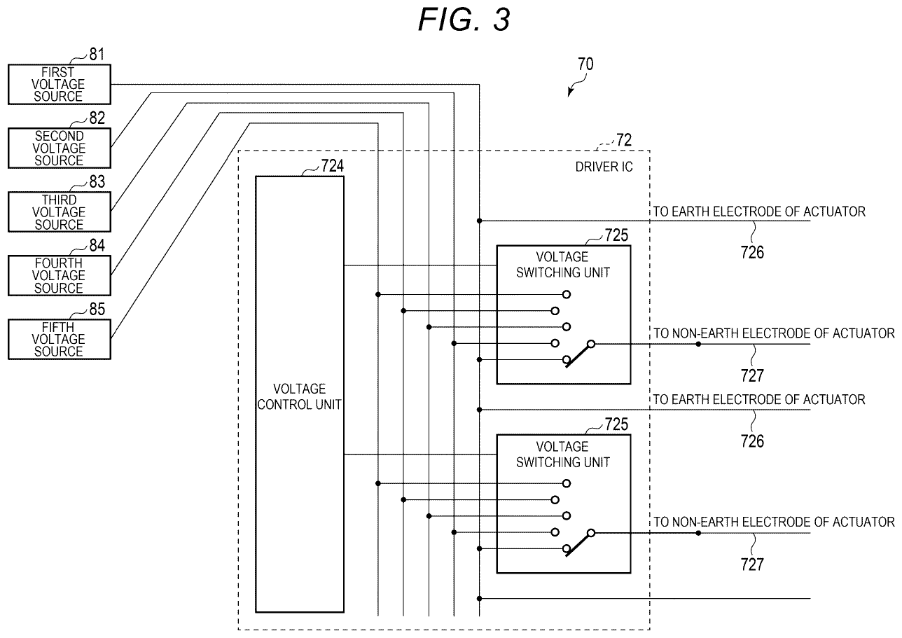

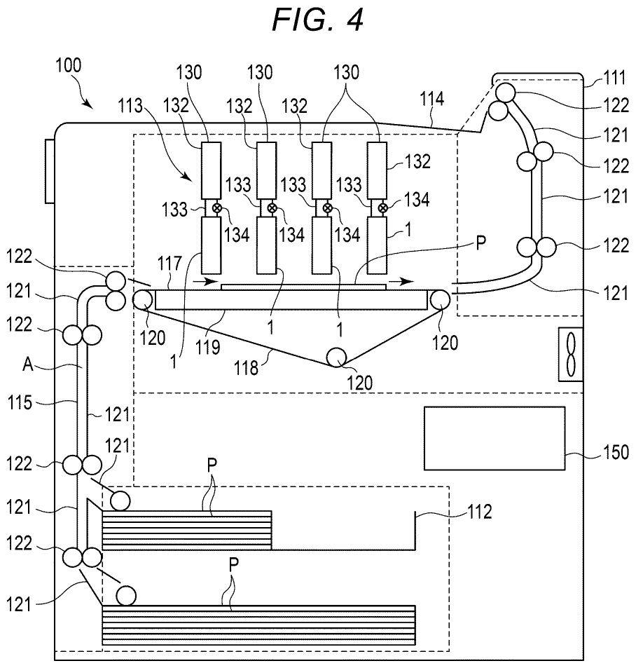

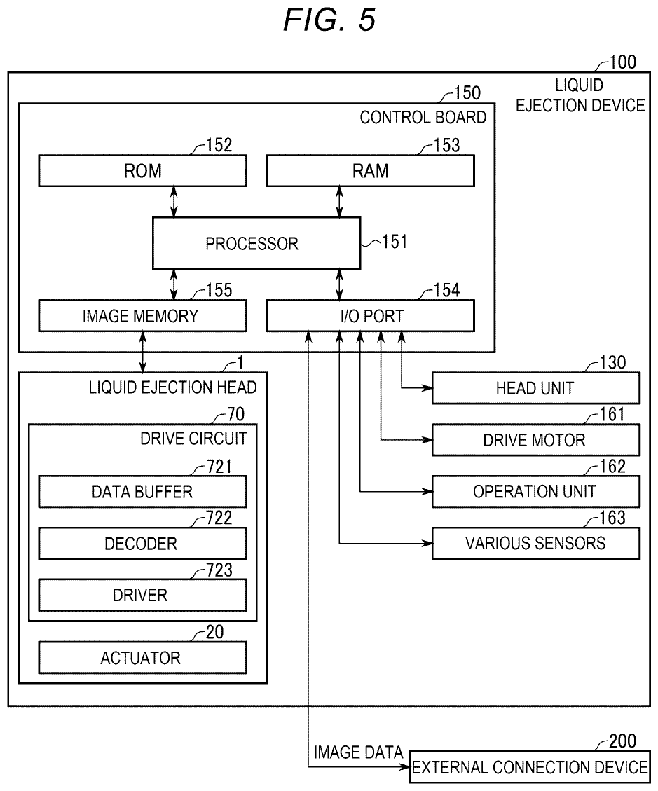

Configurations of a liquid ejection head 1 and a liquid ejection device 100 using the liquid ejection head 1 according to an embodiment will be described below with reference to FIGS. 1 to 5. FIG. 1 is a cross-sectional view showing a configuration of the liquid ejection head 1 according to an embodiment, and FIG. 2 is a cross-sectional view showing the configuration of the liquid ejection head 1. FIG. 3 is a block diagram schematically showing a configuration of a drive circuit 70 of the liquid ejection head 1. FIG. 4 is a diagram showing the configuration of the liquid ejection device 100 using the liquid ejection head 1 according to an embodiment, and FIG. 5 is a block diagram showing an example of the configuration of the liquid ejection device 100. In the drawings, a configuration is shown enlarged, reduced, or omitted as appropriate for the purpose of description.

The liquid ejection head 1 according to an embodiment is, for example, an inkjet head that ejects ink. As shown in FIGS. 1 and 2, the liquid ejection head 1 includes a base 10, an actuator 20, a vibration plate 30, a flow path plate 40, a nozzle plate 50 having a plurality of nozzles 51, and the drive circuit 70.

The base 10 is formed in, for example, a rectangular plate shape. The actuator 20 is bonded to the base 10.

The actuator 20 is, for example, a piezoelectric member including a plurality of piezoelectric pillars 21 and non-drive piezoelectric pillars 22 arranged alternately with the plurality of piezoelectric pillars 21. The actuator 20 is formed in a comb shape by arranging the plurality of piezoelectric pillars 21 and the plurality of non-drive piezoelectric pillars 22 in one direction at predetermined intervals. For example, in such an actuator 20, grooves are formed by dicing a laminated piezoelectric member bonded to the base 10 from an end surface opposite to a base 10 side, and a plurality of piezoelectric elements formed in a rectangular columnar shape are formed at predetermined intervals with respect to one piezoelectric member. Then, the plurality of formed piezoelectric elements are provided with electrodes or the like to constitute the plurality of piezoelectric pillars 21 and the plurality of non-drive piezoelectric pillars 22 which are alternately arranged as the piezoelectric elements. That is, one end side (i.e., a vibration plate 30 side) of the actuator 20 is divided into a plurality of parts by the plurality of formed grooves, and the other end side (i.e., the base 10 side) is connected.

For example, the laminated piezoelectric members constituting the actuator 20 are formed by laminating and sintering sheet-shaped piezoelectric materials. For example, as shown in FIGS. 1 and 2, the piezoelectric pillars 21 and the non-drive piezoelectric pillars 22 are, for example, laminated piezoelectric bodies as the drive elements. The piezoelectric pillar 21 and the non-drive piezoelectric pillar 22 include a plurality of laminated piezoelectric layers, a plurality of internal electrodes formed on surfaces of the piezoelectric layers, and a plurality of external electrodes. As an example, the piezoelectric pillars 21 and the non-drive piezoelectric pillars 22 have the same configuration.

The piezoelectric layer is formed of a piezoelectric material such as a lead zirconate titanate (PZT) based material or a lead-free sodium potassium niobate (KNN) based material into a thin plate shape. The plurality of piezoelectric layers are laminated in a thickness direction and bonded by sintering. A lamination direction of the piezoelectric layers is orthogonal to an arrangement direction of the piezoelectric pillars 21 and the non-drive piezoelectric pillars 22.

The internal electrode is conductive films formed in a predetermined shape and formed of a sinterable conductive material such as silver palladium. The internal electrode is formed in predetermined regions on the surfaces of the piezoelectric layers. The plurality of internal electrodes are alternately formed to have different poles in the arrangement direction.

The external electrodes are formed on surfaces of the plurality of piezoelectric pillars 21 and the plurality of non-drive piezoelectric pillars 22, and are formed by collecting end portions of the internal electrodes. The external electrode is formed of Ni, Cr, Au, or the like by a known method such as plating or sputtering. The plurality of external electrodes are disposed on different side surface portions of the plurality of piezoelectric pillars 21 and the plurality of non-drive piezoelectric pillars 22, respectively, and have different poles. The different external electrodes may be disposed in different regions on the same side surface portions of the plurality of piezoelectric pillars 21 and the plurality of non-drive piezoelectric pillars 22.

In an embodiment, the plurality of external electrodes include individual electrodes respectively formed on the plurality of piezoelectric pillars 21 and the plurality of non-drive piezoelectric pillars 22, and common electrodes continuously formed on the plurality of piezoelectric pillars 21 and the plurality of non-drive piezoelectric pillars 22. The plurality of individual electrodes formed on the plurality of piezoelectric pillars 21 and the plurality of non-drive piezoelectric pillars 22 are disposed independently of each other. The common electrode is grounded, for example.

These external electrodes are connected to, for example, the drive circuit 70. For example, each of the external electrodes is connected to a control unit 150 serving as a drive unit via a driver 723 (to be described later) of the drive circuit 70 through a wiring, and is implemented to be driven under control of a processor 151.

When a voltage is applied to the internal electrode via the external electrode, the piezoelectric pillars 21 and the non-drive piezoelectric pillars 22 vibrate longitudinally along the lamination direction of the piezoelectric layers. The term “vibrate longitudinally” referred to here is, for example, “vibrate in a thickness direction defined by a piezoelectric constant d33”. For example, as shown in FIG. 2, the plurality of alternating piezoelectric pillars 21 are disposed corresponding to pressure chambers 46 with the vibration plate 30 interposed therebetween, and the remaining non-drive piezoelectric pillars 22 are disposed at positions facing partition wall portions 42 with the vibration plate 30 interposed therebetween.

When a voltage is applied, the piezoelectric pillars 21 vibrate longitudinally to displace the vibration plate 30. That is, the piezoelectric pillars 21 deform the pressure chambers 46. The non-drive piezoelectric pillar 22 is disposed to face the partition wall portion 42. No voltage is applied to the non-drive piezoelectric pillar 22. That is, each piezoelectric pillar 21 constitutes an actuator that deforms the pressure chamber 46, and each non-drive piezoelectric pillar 22 constitutes a support pillar. That is, the piezoelectric pillar 21 changes a volume of a pressure chamber 46 by expanding and contracting the pressure chamber 46.

The vibration plate 30 is bonded to one side in the lamination direction of the piezoelectric layers of the plurality of piezoelectric pillars 21 and 22, that is, the surface on the nozzle plate 50 side. The vibration plate 30 is deformed by, for example, driving the piezoelectric pillars 21. The vibration plate 30 is bonded to the piezoelectric pillars 21 and the non-drive piezoelectric pillars 22 of the actuator 20.

The vibration plate 30 has, for example, a flat plate shape disposed such that the thickness direction corresponds to the lamination direction of the piezoelectric layer. The plane direction of the vibration plate 30 extends in the arrangement direction of the plurality of piezoelectric pillars 21 and the plurality of non-drive piezoelectric pillar 22. The vibration plate 30 is, for example, a metal plate. The vibration plate 30 has a plurality of vibration portions 301 that face the respective pressure chambers 46 and can be displaced individually. The vibration plate 30 is formed by integrally coupling the plurality of vibration portions 301.

For example, the vibration plate 30 is formed in a single flat plate shape, and regions bonded to the piezoelectric pillars 21 are individually displaced. The vibration plate 30 is formed of, for example, an SUS plate. In the vibration plate 30, a fold or a step may be formed at a portion adjacent to the vibration portion 301 or between the vibration portions 301 adjacent to each other so that the plurality of vibration portions 301 are easily displaced.

The vibration plate 30 expands and contracts the piezoelectric pillar 21 due to longitudinal vibration of the piezoelectric pillar 21, causing a portion of the vibration plate 30 opposite the piezoelectric pillar 21 to displace, thereby expanding and contracting the pressure chamber 46 and changing the volume of the pressure chamber 46.

The vibration plate 30 has a surface on one side bonded to the actuator 20 and a surface on the other side bonded to the flow path plate 40. The pressure chamber 46 capable of containing an ink is formed between the vibration plate 30 and the flow path plate 40.

One surface of the vibration plate 30 faces the piezoelectric pillars 21 and 22, and the other surface faces the pressure chambers 46 and the partition wall portions 42.

The flow path plate 40 is bonded to the vibration plate 30. The flow path plate 40 is disposed between the nozzle plate 50 and the vibration plate 30. The flow path plate 40 has the plurality of partition wall portions 42. The flow path plate 40 forms a predetermined flow path 45. For example, the flow path plate 40 is formed by laminating a plurality of plates 401 each having an opening to form a plurality of partition wall portions 42 and the predetermined flow path 45.

The plurality of partition wall portions 42 are disposed in the arrangement direction of the plurality of piezoelectric pillars 21 and 22 and face the non-drive piezoelectric pillars 22 via the vibration plate 30. The partition wall portions 42 separate the plurality of pressure chambers 46 (to be described later) of the predetermined flow path 45 and a plurality of individual flow paths 47.

The predetermined flow path 45 includes the plurality of pressure chambers 46 separated by the partition wall portions 42 of the flow path plate 40, the plurality of individual flow paths 47 separated by the partition wall portions 42, and a common flow path 48 communicating with the plurality of individual flow paths 47.

The pressure chambers 46 are arranged in the arrangement direction of the piezoelectric pillars 21 and the non-drive piezoelectric pillars 22, and face the piezoelectric pillars 21 via the vibration plate 30. The plurality of pressure chambers 46 arranged in the one direction are separated by the partition wall portions 42. The plurality of partition wall portions 42 disposed between the plurality of pressure chambers 46 face the plurality of non-drive piezoelectric pillars 22 via the vibration plate 30. The plurality of pressure chambers 46 are formed by closing one side of the flow path plate 40 with the vibration plate 30 and closing the other side with the nozzle plate 50 in the lamination direction of the piezoelectric layers. The nozzle 51 formed in the nozzle plate 50 is disposed in the pressure chamber 46.

The plurality of pressure chambers 46 communicate with the common flow path 48 via the individual flow paths 47. The pressure chamber 46 stores the liquid supplied from the common flow path 48 via the individual flow path 47, and ejects the liquid from the nozzle 51 by being deformed by the vibration of the vibration plate 30 forming a part of the pressure chamber 46. The individual flow path 47 connects the common flow path 48 and the pressure chamber 46. The individual flow paths 47 are provided in the same number as the pressure chambers 46. A flow path cross-sectional shape of the individual flow path 47 is different from a flow path cross-sectional shape of the pressure chamber 46. The flow path cross-sectional area of the individual flow path 47 is smaller than a flow path cross-sectional area of the pressure chamber 46. The common flow path 48 is fluidly connected to the plurality of individual flow paths 47 and communicates with the pressure chambers 46 through the individual flow paths 47.

The nozzle plate 50 is formed of, for example, a metal such as SUS or Ni or a resin material such as polyimide. The nozzle plate 50 is bonded to the flow path plate 40 and covers the plurality of pressure chambers 46. The nozzle plate 50 has a plurality of nozzles 51 formed at positions facing the plurality of pressure chambers 46 and penetrating in the thickness direction. A nozzle row is formed by the plurality of nozzles 51.

As shown in FIG. 5, the drive circuit 70 includes a data buffer 721, a decoder 722, and the driver 723. The data buffer 721 stores printing data in time series for each of the piezoelectric pillars 21 and 22. The decoder 722 controls the driver 723 based on the printing data stored in the data buffer 721 for each of the piezoelectric pillars 21 and 22. The driver 723 outputs drive signals for operating the piezoelectric pillars 21 and 22 under the control of the decoder 722. The drive signal is a voltage signal applied to each of the piezoelectric pillars 21 and 22.

For example, as shown in FIG. 1, the drive circuit 70 includes a wiring film 71 having one end connected to the external electrode, a driver IC 72 mounted on the wiring film 71, and a printed wiring board mounted on the other end of the wiring film 71. For example, the driver IC 72 includes the data buffer 721, the decoder 722, and the driver 723. The driver IC 72 may include a part of the data buffer 721, the decoder 722, and the driver 723, and the printed wiring board or the like may include the remaining part.

The drive circuit 70 applies a drive voltage to the external electrode by the driver IC 72 to drive the piezoelectric pillars 21, changes the volume of the pressure chambers 46, and causes droplets to be ejected from the nozzles 51.

The wiring film 71 is connected to the plurality of individual electrodes and the common electrode. For example, the wiring film 71 is an anisotropic conductive film (ACF) fixed to connection portions with the external electrode by thermo-compression bonding or the like. The wiring film 71 is, for example, a chip on film (COF) on which the driver IC 72 is mounted.

The driver IC 72 is connected to the external electrode via the wiring film 71. Instead of the wiring film 71, the driver IC 72 may be connected to the external electrode by other methods such as an anisotropic conductive paste (ACP), a non-conductive film (NCF), and a non-conductive paste (NCP).

The driver IC 72 applies a control signal and a drive signal to the respective piezoelectric pillars 21 and 22 to operate the piezoelectric pillars 21. The driver IC 72 generates, according to an image signal input from the control unit 150 of the liquid ejection device 100, a control signal for controlling a timing of ejecting the ink and selecting the piezoelectric pillar 21 that ejects the ink. The driver IC 72 generates a voltage to be applied to the piezoelectric pillar 21, that is, a drive signal, according to the control signal. When the driver IC 72 applies the drive signal to the piezoelectric pillar 21, the piezoelectric pillar 21 displaces the vibration plate 30, thereby driving the pressure chamber 46 to change the volume to expand and contract. Accordingly, the ink filled in the pressure chamber 46 is caused to perform pressure vibration. Due to the pressure vibration, the ink is ejected from the nozzle 51 provided in the pressure chamber 46. The liquid ejection head 1 may be implemented to express gradation by changing an amount of ink droplets that land on a portion of a medium corresponding to one pixel. The liquid ejection head 1 may be implemented to change the amount of ink droplets by changing the number of times of ink ejection. In this manner, the driver IC 72 is an example of an application unit that applies a drive signal to the piezoelectric pillar 21.

Next, an example of the drive circuit 70 will be described with reference to FIG. 3. The drive circuit 70 includes, for example, a voltage control unit 724 and the same number of voltage switching units 725 as the pressure chambers 46 in the driver IC 72. However, in FIG. 3, two voltage switching units 725 are shown, and other voltage switching units 725 are not shown.

The drive circuit 70 is connected to a first voltage source 81, a second voltage source 82, a third voltage source 83, a fourth voltage source 84, and a fifth voltage source 85. The drive circuit 70 applies a voltage supplied from the first voltage source 81 to each wiring electrode 726. The drive circuit 70 selectively applies, to wiring electrodes 727, the voltages supplied from the first voltage source 81, the second voltage source 82, the third voltage source 83, the fourth voltage source 84, and the fifth voltage source 85. Here, if the actuator 20 is a laminated PZT, since there is a tendency to deteriorate when a bipolar voltage is applied, the voltages supplied by the first voltage source 81, the second voltage source 82, the third voltage source 83, the fourth voltage source 84, and the fifth voltage source 85 are set to a ground voltage and either positive or negative with respect to the ground voltage.

An output voltage of the first voltage source 81 is, for example, a ground voltage, and a voltage value thereof is V0 (V0=0 [V]). A voltage value indicated by the output voltage of the second voltage source 82 is V1. The voltage value V1 is higher than V0. A voltage value indicated by the output voltage of the third voltage source 83 is, for example, V2. For example, the voltage value V2 is higher than V0 and lower than V1. A voltage value indicated by the output voltage of the fourth voltage source 84 is V3. The voltage value V3 is lower than V0. A voltage value indicated by the output voltage of the fifth voltage source 85 is, for example, V4. For example, the voltage value V4 is lower than V0 and higher than V3.

The wiring electrode 726 is connected to a common electrode as an earth electrode of the actuator 20. Each of the plurality of wiring electrodes 727 is connected to an individual electrode as a non-earth electrode of the actuator 20.

The voltage control unit 724 is connected to each of the plurality of voltage switching units 725. The voltage control unit 724 outputs, to each voltage switching unit 725, a command indicating which voltage source among the first voltage source 81, the second voltage source 82, the third voltage source 83, the fourth voltage source 84, and the fifth voltage source 85 is selected. For example, the voltage control unit 724 receives an image signal from the control unit 150 and determines a switching timing of the voltage source in each voltage switching unit 725. Further, the voltage control unit 724 outputs the command to select any one of the first voltage source 81, the second voltage source 82, the third voltage source 83, the fourth voltage source 84, and the fifth voltage source 85 to the voltage switching unit 725 at a determined switching timing. The voltage switching unit 725 switches the voltage source connected to the wiring electrode 727 according to the command from the voltage control unit 724.

The voltage switching unit 725 includes, for example, a semiconductor switch. The voltage switching unit 725 connects any one of the first voltage source 81, the second voltage source 82, the third voltage source 83, the fourth voltage source 84, and the fifth voltage source 85 to the wiring electrode 727 under the control of the voltage control unit 724. Therefore, the internal electrodes of different poles of the piezoelectric pillar 21 are connected to the wiring electrode 726 and the wiring electrode 727 via the external electrodes (i.e., the common electrode and the individual electrode).

Such a drive circuit 70 switches a connection wiring between the voltage sources 81, 82, 83, 84, and 85 and the actuator 20 using the switching circuit including the voltage control unit 724 and the plurality of voltage switching units 725, and inputs drive waveforms having at least three types of potential differences as drive signals between the electrodes of the actuator 20. Here, the drive waveform is a drive waveform by which droplets are ejected by driving the actuator 20. Here, a potential difference other than the largest potential difference and the smallest potential difference is referred to as an intermediate potential difference.

The printed wiring board is a printing wiring assembly (PWA) on which various electronic components or connectors are mounted. The printed wiring board is connected to the control unit 150 of the liquid ejection device 100.

Next, an example of the liquid ejection device 100 including the liquid ejection head 1 will be described with reference to FIGS. 4 and 5. The liquid ejection device 100 is, for example, an inkjet printing device. The liquid ejection device 100 includes a housing 111, a medium supply unit 112, an image forming unit 113, a medium discharge unit 114, and a conveying device 115. In addition, the liquid ejection device 100 includes the control unit 150.

The liquid ejection device 100 executes image forming processing on sheets P by ejecting liquid such as ink while conveying the sheet P serving as a printing medium that is an ejection target along a predetermined conveying path A from the medium supply unit 112 to a medium discharge unit 114 through the image forming unit 113.

The housing 111 is an outer shell of the liquid ejection device 100. A discharge port through which the sheet P is to be discharged to the outside is provided at a predetermined position of the housing 111.

The medium supply unit 112 includes a plurality of sheet feed cassettes, and can hold a plurality of sheets P of various sizes in a manner of laminating the sheets P.

The medium discharge unit 114 includes a sheet discharge tray that can hold the sheet P discharged from the discharge port.

The image forming unit 113 includes a support portion 117 that supports the sheet P, and a plurality of head units 130 facing the support portion 117 above the support portion 117.

The support portion 117 includes a conveying belt 118 provided in a loop shape in a predetermined region where image formation is performed, a support plate 119 that supports the conveying belt 118 from a back side, and a plurality of belt rollers 120 provided on the back side of the conveying belt 118.

During the image formation, the support portion 117 supports the sheet P on a holding surface that is an upper surface of the conveying belt 118, and conveys the sheet P to a downstream side by sending the conveying belt 118 at a predetermined timing by rotation of the belt rollers 120.

The head unit 130 includes the liquid ejection head 1, a plurality of ink tanks 132 as liquid tanks mounted on the liquid ejection head 1, a connection flow path 133 that connects the liquid ejection head 1 and the ink tanks 132, and a supply pump 134.

In one embodiment, a plurality of head units 130 are provided. The head units 130 use inks of different colors. For example, the plurality of head units 130 include the liquid ejection heads 1 of four colors of cyan, magenta, yellow, and black and the ink tanks 132 that respectively store the inks of the respective colors. The ink tank 132 is connected to the common flow path 48 of the liquid ejection head 1 by the connection flow path 133.

A negative pressure control device such as a pump (not shown) is connected to the ink tank 132. A negative pressure in the ink tank 132 is controlled by the negative pressure control device according to water head values of the liquid ejection head 1 and the ink tank 132, thereby forming the ink supplied to each nozzle 51 of the liquid ejection head 1 into a meniscus having a predetermined shape.

The supply pump 134 is, for example, a liquid sending pump formed of a piezoelectric pump. The supply pump 134 is provided in a supply flow path. The supply pump 134 is connected to the control unit 150 by wiring and is controlled by the control unit 150. The supply pump 134 supplies the liquid to the liquid ejection head 1.

The conveying device 115 conveys the sheet P along the conveying path A that runs from the medium supply unit 112 through the image forming unit 113 to the medium discharge unit 114. The conveying device 115 includes a plurality of guide plate pairs 121 disposed along the conveying path A and a plurality of conveying rollers 122.

Each of the plurality of guide plate pairs 121 includes a pair of plate members facing each other across the sheet P to be conveyed, and guides the sheet P along the conveying path R.

The conveying roller 122 is driven and rotated under the control of the control unit 150, thereby conveying the sheet P to the downstream side along the conveying path A. Sensors that detect a sheet conveying state are disposed at various positions in the conveying path A.

The control unit 150 is, for example, a control board or circuit. The control unit 150 includes a processor 151, a read only memory (ROM) 152, a random access memory (RAM) 153, an I/O port 154 as that is an input and output port, and an image memory 155.

The processor 151 is a processing circuit such as a central processing unit (CPU) which serves as a control unit. The processor 151 controls the head unit 130, a drive motor 161, an operation unit 162, various sensors 163, and the like provided in the liquid ejection device 100 through the I/O port 154. The processor 151 transmits printing data stored in the image memory 155 to the drive circuit 70 in a drawing order.

The ROM 152 stores various programs. The RAM 153 temporarily stores various types of variable data, image data, and the like. The ROM 152 and the RAM 153 are examples of memories, and other memories or storage media may be used to store various programs, data, and the like. The I/O port 154 is an interface unit that inputs data from the outside of an externally connected device 200 and outputs data to the outside. The printing data from the externally connected device 200 is transmitted to the control unit 150 through the I/O port 154, and is stored in the image memory 155.

Hereinafter, characteristics of the liquid ejection head 1 used in the liquid ejection device 100 and a drive waveform (a drive signal for ejecting a droplet) of the liquid ejection head 1 according to a comparative example as a related art will be described.

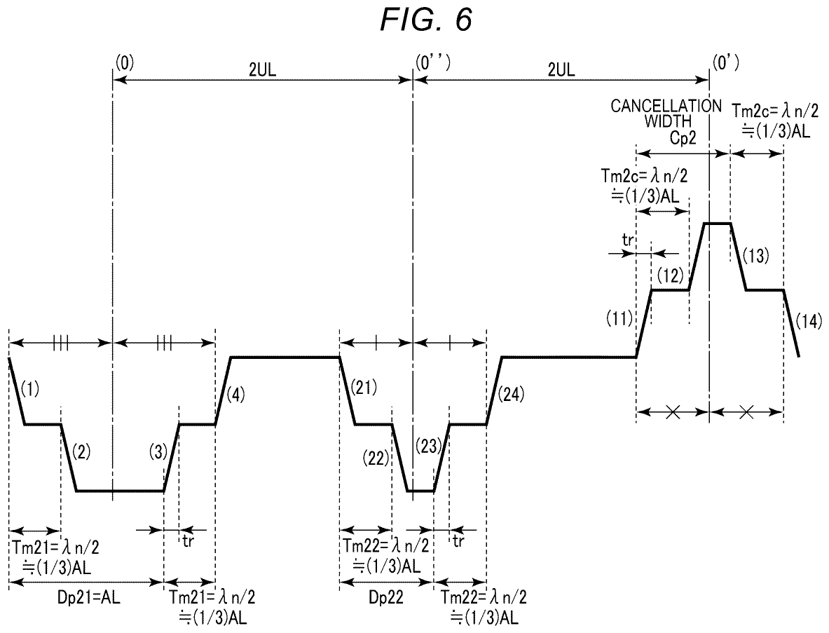

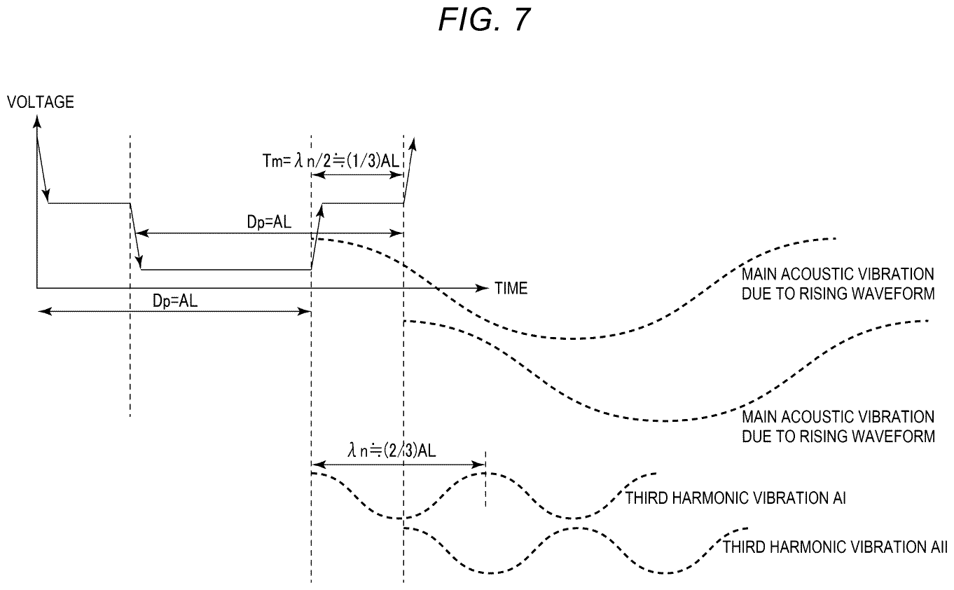

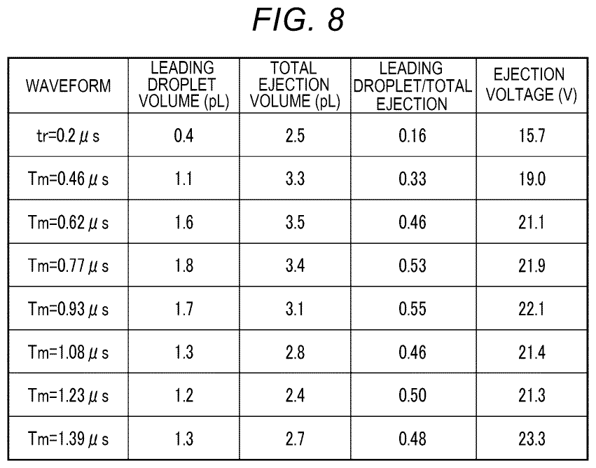

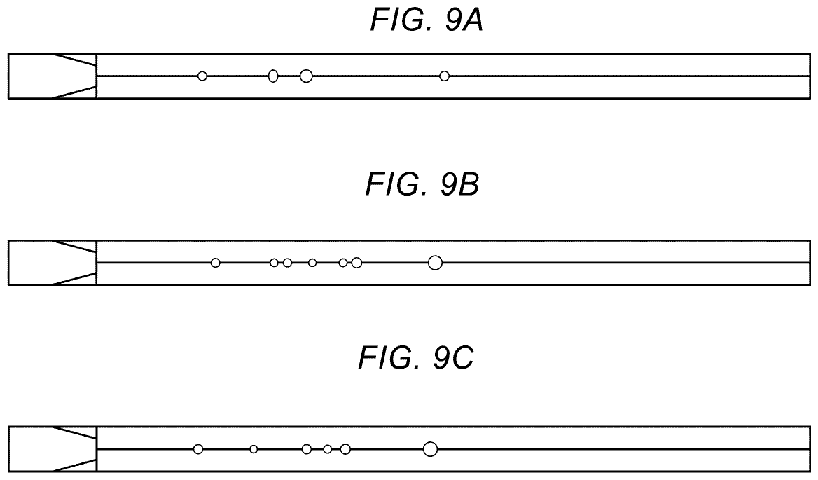

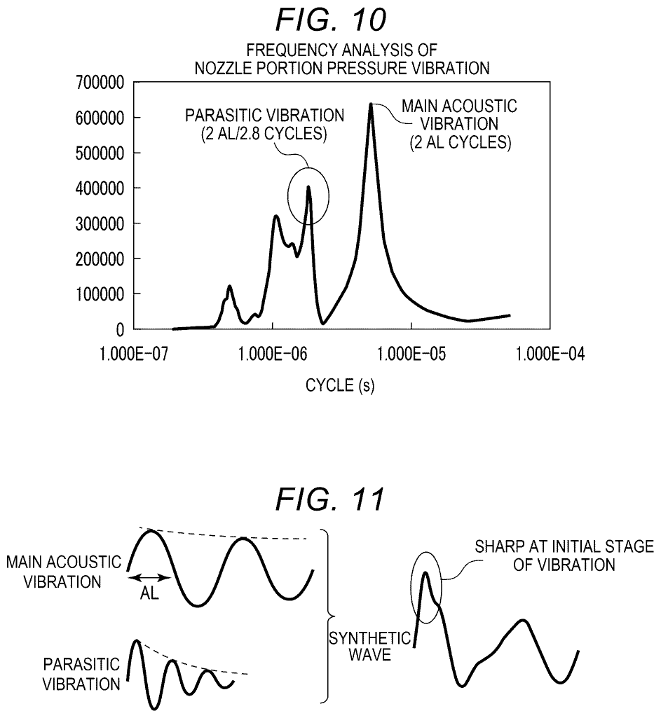

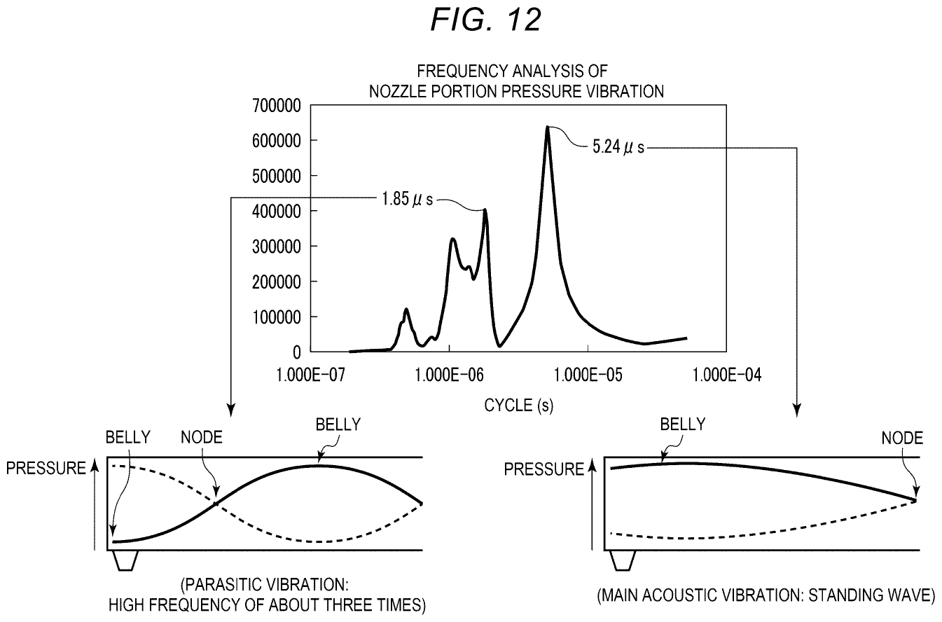

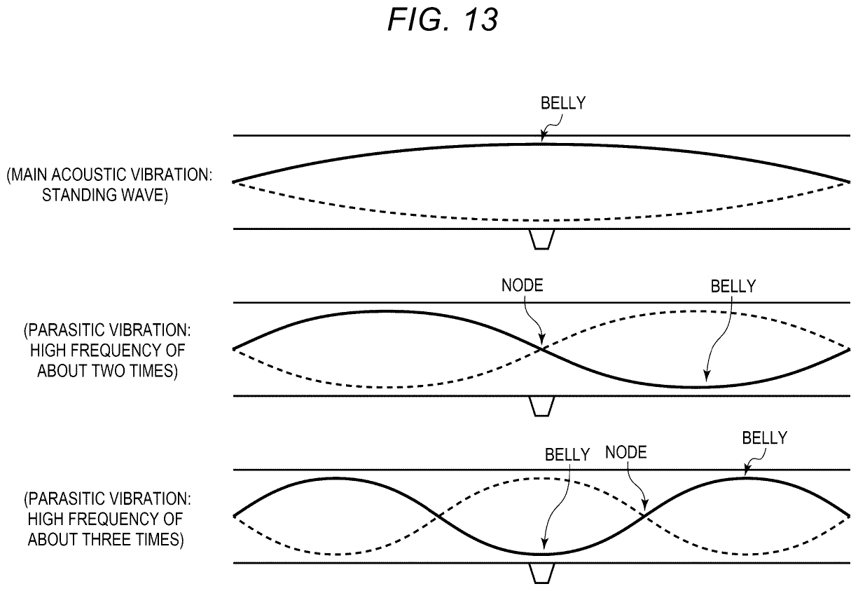

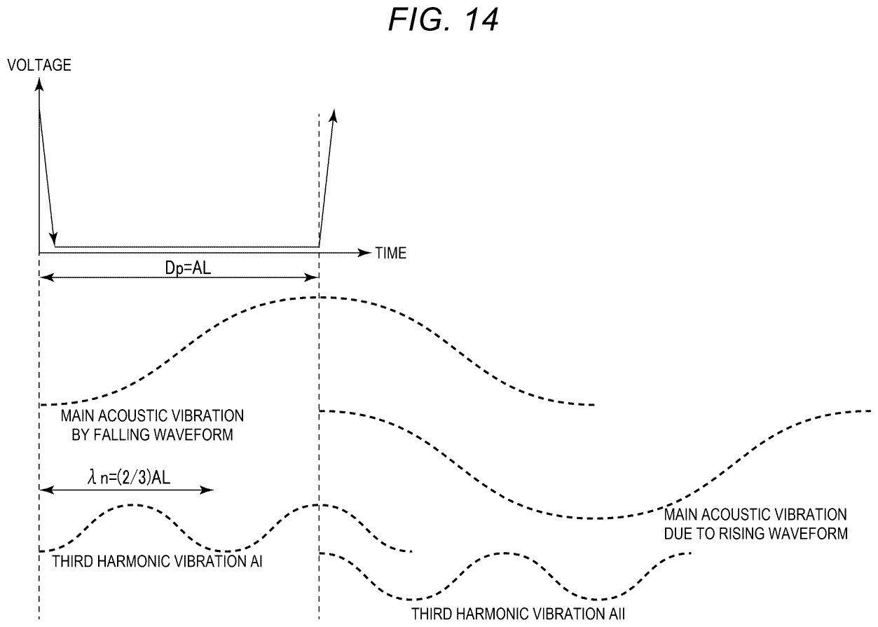

First, a drive waveform of the liquid ejection head 1 according to the comparative example will be described with reference to FIGS. 6 to 14. FIG. 6 is a diagram showing an example of a drive waveform including a multi-drop ejection waveform and a cancel waveform for continuously ejecting a plurality of droplets from the liquid ejection head 1 according to the comparative example. FIG. 7 is a diagram showing an example of one ejection waveform and acoustic vibration of the liquid ejection head 1 according to one embodiment, FIG. 8 is a diagram showing a relation between the ejection waveform and the ejection droplet in the example of the liquid ejection head 1 according to one embodiment, and FIG. 9 is a diagram showing an example of the ejection droplet of the liquid ejection head 1 according to one embodiment. FIGS. 10 to 14 are diagrams related to the liquid ejection head according to the comparative example. Specifically, FIG. 10 is a diagram showing an example of frequency analysis of a pressure vibration of the liquid ejection head according to the comparative example, and FIG. 11 is a diagram showing an example in which a main acoustic vibration and a parasitic vibration of FIG. 10 are combined. FIG. 12 is a diagram showing an example of the frequency analysis of the liquid ejection head according to the comparative example, FIG. 13 is a diagram showing an example of a drive waveform and an acoustic vibration of the liquid ejection head according to the comparative example, and FIG. 14 is a diagram showing an example of the drive waveform and the acoustic vibration of the liquid ejection head according to the comparative example.

First, in the liquid ejection head of the related art, there is a drive method referred to as so-called pull driving in which an ejection force is increased by driving the piezoelectric pillar 21 according to a half cycle AL of a main acoustic vibration of the pressure chamber. However, as shown in the example of the frequency analysis of the pressure vibration of the nozzle portion in FIG. 10, when the liquid ejection head (or the actuator) is driven to eject the droplets from the nozzles, in addition to the main acoustic vibration due to a fluid vibration of the ink, a parasitic vibration may occur in the pressure chamber in a frequency region higher than that of the main acoustic vibration.

When a droplet is ejected from the nozzle by driving the actuator, if a parasitic vibration having a frequency higher than that of the main acoustic vibration occurs, as shown in FIG. 11, a pressure peak having a cycle shorter than a half cycle of the main acoustic vibration occurs in the pressure of the pressure chamber. That is, a combined wave obtained by synthesizing the main acoustic vibration and the parasitic vibration is sharp at an initial stage of vibration. The pressure peak of the short cycle increases an ejection speed of a front end portion of the ejection droplet, but does not continue until the end of the ejection, and decreases the ejection speed of a rear end portion of the ejection droplet. Then, as shown in the upper part FIG. 9A, when a droplet is ejected, a volume of a satellite relative to a leading droplet increases, resulting in a deterioration in printing quality. Here, the satellite is a droplet that is ejected following a droplet that is initially ejected (i.e., a leading droplet) and spaced apart from the leading droplet when the piezoelectric pillar 21 is driven and the pressure chamber is deformed to eject the liquid from the nozzle.

For example, in the liquid ejection head in the related art, as shown in the frequency analysis of FIG. 12, in addition to the main acoustic vibration, approximately three times (for example, 2.8 times) parasitic vibration occurs. Here, the following can be considered as a cause of the parasitic vibration having a frequency higher than the main acoustic vibration in the pressure chamber of the liquid ejection head.

An example of the cause is an odd multiple vibration of three or more in the liquid column vibration of a closed tube, and an example of such a liquid ejection head is an end shooter having an opening end at a connection point with the common flow path as shown in FIG. 12.

Another example of the cause is an integral multiple vibration of two or more in the liquid column vibration of an open tube, and an example of such a liquid ejection head is a side shooter having an opening end at a connection point with the common flow path as shown in FIG. 13. In the main acoustic vibration of the open tube, an amplitude of the pressure vibration is largest at a center portion of the open tube, and thus the nozzle is provided in the vicinity of the center portion of the open tube. As shown in FIG. 13, when two or more even multiple vibrations are generated in a liquid column vibration of the open tube, the center portion of the open tube becomes a vibration node where the amplitude of the pressure vibration is small, and therefore, if the nozzle is provided in the vicinity of the center portion of the open tube, a shape of the ejected droplets is less susceptible to the effects of the even multiple vibrations of two or more. Therefore, if the nozzle is provided in the vicinity of the center portion of the open tube, the odd multiple vibration of three or more tends to be a factor that increases the volume of the satellite and deteriorates the printing quality more than the even multiple vibrations of two or more.

Another example of the cause is a vibration caused by reflection of the pressure vibration due to a change in a sound speed of each flow path when flow path cross sections of the pressure chamber and the individual flow path are different.

Another example of the cause is a vibration caused by a factor that, if rigidity of a wall surface or a part of the wall surface of the individual flow path is smaller than that of the pressure chamber, a pressure generated in the pressure chamber is reduced in the flow path having small rigidity, and a pressure vibration node is generated between the pressure chamber and the flow path having small rigidity. This is, for example, a case in which an installation range of the actuator (i.e., the piezoelectric pillar 21) such as the PZT indicated by a two-dot chain line in FIG. 1 is biased with respect to a range of a vibration plate on the wall surface of the pressure chamber due to a manufacturing error or the like, as in the actuator indicated by a solid line in FIG. 1, and an area of the range of the vibration plate of the pressure chamber wall surface that is only supported by the vibration plate and not the actuator is relatively large. FIGS. 10 and 12 are graphs showing results of frequency analysis of the pressure vibration in the nozzle portion when performing a simulation in which the deformation of PZT or a pressure chamber is subjected to structural analysis, a liquid behavior of a flow path is subjected to compressive fluid analysis, and droplet ejection from a nozzle is subjected to fluid surface analysis, with respect to a head in a case in which a range in which an actuator is not supported by only the vibration plate on an upper right side of a pressure chamber in FIG. 1 is a range of about less than 30% of a length in the longitudinal direction of the pressure chamber (a horizontal width of the pressure chamber 46 in FIG. 1).

Further, as shown in FIG. 14, when a rectangular wave width Dp of the ejection waveform is AL, since a third harmonic vibration AI generated by pressure chamber expansion (i.e., a falling waveform) in advance before ejection and a third harmonic vibration AII of the liquid column vibration generated by pressure chamber contraction (i.e., a rising waveform) during ejection strengthen each other, a pressure peak of a short cycle is generated due to the third harmonic vibration, leading to a deterioration in the printing quality.

Next, driving and drive waveforms of the liquid ejection head 1 according to a comparative example will be described. In the comparative example, the pressure vibration of the pressure chamber 46 of the liquid ejection head 1 is regarded as a liquid column vibration of a closed tube, and is set to a drive waveform that reduces a third harmonic vibration in which an acoustic resonance frequency (i.e., a parasitic vibration) in a frequency region higher than a main acoustic resonance frequency (i.e., a main acoustic vibration) of the liquid in the pressure chamber 46 is substantially an odd multiple of the main acoustic resonance frequency that is substantially three times or more. Here, as shown in FIG. 10, approximately three times includes 2.8 times. The drive waveform of the liquid ejection head 1 shows an example in which droplets are continuously ejected twice as shown in FIG. 6 as an example of the multi-drop in which a plurality of droplets are continuously ejected.

First, in the liquid ejection head 1, when the potential difference is the smallest, the pressure chamber 46 is expanded to the largest extent by the piezoelectric pillar 21 of the actuator 20, and when the potential difference is the largest, the ink pressure chamber 46 is contracted to the smallest extent by the piezoelectric pillar 21 of the actuator 20. Further, when the ink is ejected by the liquid ejection head 1, the pressure chamber 46 is reduced in advance before ejection, the pressure chamber 46 is expanded immediately before ejection, and the pressure chamber 46 is reduced during ejection, thereby ejecting the ink. In the example, the ejection waveform of the drive waveform of the liquid ejection head 1 is set such that, before ejection, a potential difference (i.e., an expansion potential difference) including the intermediate potential difference is reduced twice continuously as a plurality of times during the expansion of the pressure chamber 46 immediately before ejection, or, during ejection, a potential difference (i.e., a contraction potential difference) including the intermediate potential difference is increased twice continuously as a plurality of times during contraction of the pressure chamber 46. More preferably, the ejection waveform continuously changes the potential difference twice both when the pressure chamber 46 expands and when the pressure chamber 46 contracts. Then, the liquid ejection head 1 ejects the droplets twice by continuously inputting such an ejection waveform twice.

In order to eject the ink from the liquid ejection head 1 a plurality of times, in the example, twice, after the second ejection waveform is continuously input, a cancel waveform is input to cancel out the residual vibration that is generated after the ejection of the ink. In the following description, the first ejection waveform may be referred to as a first drop ejection waveform, and the second ejection waveform may be referred to as a second drop ejection waveform.

In the example, the cancel waveform of the drive waveform of the liquid ejection head 1 has a waveform width (i.e., a cancel width) Cp of the cancel waveform smaller than AL. In the example, in addition to the contraction of the pressure chamber 46 performed during ejection, the potential difference including the intermediate potential difference is continuously increased twice as a plurality of times when the pressure chamber 46 is contracted, and the potential difference including the intermediate potential difference is continuously decreased twice as a plurality of times when the pressure chamber 46 is expanded. More preferably, similarly to the ejection waveform, the cancel waveform continuously changes the potential difference twice both when the pressure chamber 46 expands and when the pressure chamber 46 contracts.

FIG. 6 shows an example of the drive waveform in which the ejection waveform is continuously input twice at predetermined intervals when the liquid ejection head 1 ejects the ink. FIG. 7 shows an example of the ejection waveform. In FIGS. 6 and 7, a vertical axis represents a voltage (i.e., a potential difference), and a horizontal axis represents a time. The drive waveform is generated by the driver IC 72 of the drive circuit 70. As shown in FIG. 6, in the drive waveform, in both the two ejection waveforms and the cancel waveform, the expansion potential difference is reduced twice when the pressure chamber 46 is expanded, and the contraction potential difference is increased twice when the pressure chamber 46 is contracted during ejection. When the potential difference is changed both when the pressure chamber 46 is expanded and when the pressure chamber is contracted, after a first potential difference is applied, the first potential difference is maintained for a predetermined time, and then a second potential difference is applied. When the pressure chamber 46 is expanded when the voltage is reduced, the voltage is increased in order to contract the pressure chamber 46 in advance before the ejection waveform is input.

First, an example of the ejection waveform of a first drop among the drive waveforms will be specifically described with reference to FIGS. 6 and 7. As shown in FIG. 7, when the pressure chamber 46 is expanded in advance before the ink is ejected, a time interval from a first expansion start time point due to the expansion potential difference when the potential difference is continuously reduced twice to a first contraction start time point due to the contraction potential difference after the potential difference is continuously reduced twice by the expansion potential difference is set as Dp. In addition, as shown in FIG. 7, when the pressure chamber 46 is contracted during ejection, a time interval from a second expansion start time point due to the expansion potential difference when the potential difference is continuously reduced twice before the potential difference is increased to a second contraction start time point due to the contraction potential difference when the potential difference is continuously reduced twice by the expansion potential difference and then continuously increased twice by the contraction potential difference is set as Dp.

The time width Dp is larger than 0.5AL and less than 1.5AL. More preferably, Dp=AL. This is because if Dp is larger than 0.5AL and less than 1.5AL, the main acoustic vibration generated by expanding the pressure chamber 46 in advance before ejection and the main acoustic vibration generated by contracting the pressure chamber 46 during ejection strengthen each other.

Here, the drive waveform is Tm=λn/2, where λn is a cycle of the parasitic vibration such as the third harmonic, and Tm is a time interval between a first potential difference change start time and a second potential difference change start time when the potential difference is continuously increased twice or when the potential difference is continuously reduced twice. When the piezoelectric pillar 21 (i.e., the actuator) is driven with such a drive waveform, as shown in FIG. 7, the phase difference between the parasitic vibration generated at the time of the first potential difference change and the parasitic vibration generated at the time of the second potential difference change becomes 180 degrees and cancels out each other. Accordingly, it is possible to prevent a deterioration in the printing quality due to the parasitic vibration such as the third harmonic. In FIG. 7, the pressure reaches a maximum at the moment the pressure chamber 46 is contracted due to the rising waveform. In the case of a meniscus flow speed of the nozzles facing downward as shown in FIG. 1, the speed reaches its maximum downward speed ¼ cycle after the moment when the pressure chamber 46 is contracted due to the rising waveform, which is the center of the amplitude. Hereinafter, the main acoustic vibration indicates a vibration with a cycle of 2AL, and the third harmonic indicates a vibration with a cycle of λn.

More preferably, in the drive waveform, as shown in FIG. 7, by setting the potential difference change amount of the first potential difference change and the potential difference change amount of the second potential difference change to be the same, the parasitic vibrations having substantially the same amplitude in the pressure chamber 46 and having a phase difference of 180 degrees cancel out each other, and the subsequent residual vibration derived from the parasitic vibrations can be significantly reduced.

As described above, in a case in which a time width Dp of the ejection waveform (i.e., the drive waveform) in a case in which a potential difference is continuously increased twice or in a case in which the potential difference is continuously decreased twice is set as AL, and a time interval Tm is set as λn/2, as shown in FIG. 7, a phase difference between the parasitic vibration (i.e., the third harmonic vibration AI) generated by the pressure chamber contraction (i.e., the rising waveform) during a first potential difference change and the parasitic vibration generated by the pressure chamber contraction during a second potential difference change is 180 degrees, and the parasitic vibrations cancel out each other. If the time interval Tm is smaller than 0.5AL, the main acoustic vibration generated by the pressure chamber contraction at the time of the first potential difference change and the main acoustic vibration generated by the pressure chamber contraction at the time of the second potential difference change strengthen each other. By setting Dp to AL, the main acoustic vibration generated by the pressure chamber expansion (i.e., the falling waveform) in advance before ejection and the main acoustic vibration generated by the pressure chamber contraction during ejection strengthen each other, and the ejection force by the main acoustic vibration increases. When the pressure chamber 46 is expanded when the voltage is reduced, the voltage is increased in order to contract the pressure chamber 46 in advance before the ejection waveform is input.

Here, a condition of Tm in which the parasitic vibrations of the cycle λn weaken each other in the drive waveform will be described. First, it is assumed that the vibration with the cycle λn generated at the time of the first potential difference change is A and the vibration vector after the time Tm of A is A′. A vibration vector with the cycle λn generated at the time of the second potential difference change after Tm is set as B. When Tm is an odd multiple of λn/2 (the phase difference between A′ and B is 180 degrees), an absolute value of a combined vector of A′ and B is minimized. When a condition that the absolute value of the combined vector of A′ and B is equal to or smaller than the larger absolute value of A′ and B (equal to or smaller than the absolute value of A′ when the absolute value of A′ and the absolute value of B are the same) is obtained based on the formula for combining simple harmonic vibrations with the cycle λn, the phase difference between the vibration vectors A′ and B is within 180 degrees±60 degrees.

The absolute value of the combined vector of A′ and B can be transformed into the following formula. Here, when θA is the phase of A′ and θB is the phase of B, A′=|A′| (cos θA, sin θA) and B=|B| (cos θB, sin θB). In this case, the absolute value of the combined vector of A′ and Bis √(|A′|\hat{ }2+|B|\hat{ }2+2*|A′|*|B|*cos(θA−θB)) (Math. 1). Here, when |A′|≤|B|, a phase difference (θA−θB) between A′ and B at which |B|≥Math. 1 is satisfied is a condition for the vibrations of the cycle λn to weaken each other. When |B|≥Math. 1 is squared on both sides and transformed, 0≥|A′|+2*|B|*cos(θA−θB) (Math. 2) is obtained. From the above, if the phase difference (θA−θB) between A′ and B is within the range of 180 degrees±60 degrees, Math. 2 is established.

In the case of |B|≤|A′|, when both sides of |A′|≥Math. 1 are squared and transformed, 0≥|B|+2*|A′|*cos(θA−θB) (Math. 3) is obtained. From the above, if the phase difference (θA−θB) between A′ and B is within the range of 180 degrees±60 degrees, Math. 3 is established.

From these, the condition for the parasitic vibration of the cycle λn to weaken each other is (k/2−1/6)λn≤Tm≤(k/2+1/6)λn (Math. 4). Here, k is an odd number of 1 or more.

In addition, when the potential difference is continuously changed twice both when the pressure chamber 46 is expanded and when the pressure chamber 46 is contracted, Tm of the drive waveform is preferably (k/2−1/6)λn≤Tm≤(k/2+1/6)λn (k is an odd number of 1 or more) for both an intermediate potential difference holding time during the pressure chamber expansion and an intermediate potential difference holding time during the pressure chamber contraction.

It is desirable that Tm is short from the viewpoint of reducing power consumption by strengthening main acoustic vibrations generated at the time of change from the potential difference immediately before the corresponding intermediate potential difference to the next potential difference.

From the above point, when the reduction of the power consumption is also considered, Tm of the drive waveform is (k/2−1/6)λn≤Tm≤kλn/2 (Math. 5). Here, k is an odd number of 1 or more.

As an evaluation of the ejection waveform for the first drop among the drive waveforms of the liquid ejection head 1, FIG. 8 shows results when the liquid ejection head 1 with 2AL=5.24 μs is driven with various waveforms and one drop of ink is ejected. Voltages are adjusted such that a leading droplet speed is approximately 8 m/s in all the results of the various waveforms in FIG. 8.

The uppermost drive waveform in FIG. 8 is a trapezoidal drive waveform as shown in FIG. 14 in which a rise time tr is 0.2 μs as a comparative example, and other drive waveforms are drive waveforms in which a twice potential difference change is performed as shown in FIG. 7, with different Tm, and all of the rise times being 0.2 μs. An ejection voltage indicates a difference between the expansion potential difference and the contraction potential difference. The intermediate potential difference is an intermediate value between the expansion potential difference and the contraction potential difference.

In the liquid ejection head 1, for example, as shown in the frequency analysis of FIG. 12, a parasitic vibration of approximately three times is generated in addition to the main acoustic vibration. The cycle λn of the parasitic vibration is 1.85 μs, and λn/2 is 0.925 μs.

FIGS. 9A, 9B, and 9C show a simulation result of the state of the ejection droplet when the ink is dropped by one drop. In FIGS. 9A, 9B, and 9C, FIG. 9A shows an example of an ejection droplet having a trapezoidal drive waveform in which tr=0.2 μs according to a comparative example, FIG. 9B shows an example of an ejection droplet having a drive waveform in which Tm=0.62 μs and the twice potential difference change is performed, and FIG. 9C shows an example of an ejection droplet having a drive waveform in which Tm=0.93 μs and the twice potential difference change is performed.

As shown in FIGS. 8 and 9C, the waveform of Tm=0.93 μs, which is closest to the half cycle of the parasitic vibration, has a largest ratio of a leading droplet volume to a total ejection volume, and as shown in the central diagram (b) of FIGS. 8 and 9, it can be seen that the ratio of the leading droplet volume tends to decrease as Tm deviates from 0.925 μs. In addition, it is found that an ejection voltage per unit volume (i.e., ejection voltage/total ejection volume) tends to decrease as Tm decreases. These results also show that the drive waveform for the liquid ejection head 1 at the first drop can prevent vibrations at frequencies higher than the main acoustic vibration while reducing the power consumption.

Next, an example of the ejection waveform of the second drop among the drive waveforms will be specifically described with reference to FIG. 6. In the comparative example, the ejection waveform of the second drop has a smaller time width Dp until the first contraction start time point due to the contraction potential difference after being continuously reduced twice by the expansion potential difference than the ejection waveform of the first drop. For example, while Dp21 of the ejection waveform of the first drop is the same as AL, Dp22 of the ejection waveform of the second drop is set to be smaller than AL.

Here, for the sake of simplicity, a vibration attenuation due to a viscous resistance of the flow path or the like is ignored, a time when potential difference change due to tr is generated is set as tin, a time at a phase reference point (0) is set as t0, and the pressure vibration of the pressure chamber 46 due to pressurization is schematically represented by cos((t0−tin)*(π/AL)). A liquid speed in a nozzle portion is −sin((t0−tin)*(π/AL)). Here, when a direction of the nozzle is downward, since the liquid speed in the nozzle portion changes downward due to the pressurization of the pressure chamber 46, a minus sign is given to a formula of the liquid speed in the nozzle portion. In addition, a time when the potential difference change due to tf is generated is set as tin, and the pressure vibration of the pressure chamber 46 due to depressurization is schematically represented by cos(−π+(t0−tin)*(π/AL)). The liquid speed in the nozzle portion is-sin (−π+(t0−tin)*(π/AL)). Here, when the direction of the nozzle is downward, since the liquid speed in the nozzle portion changes upward due to the depressurization of the pressure chamber 46, a minus sign is given to a formula of the liquid speed in the nozzle portion.

Thereafter, basically, the phase reference point (0) or (0″) is used as a reference, and an elapsed time (a phase progress) from the occurrence time of a step input of each voltage to the reference point is substituted into (t0−tin). Accordingly, the phase of each potential difference change or its combined wave with respect to the reference point (0) or (0″) will be described.

Here, for convenience of description, in FIG. 6, first to fourth potential difference changes in the ejection waveform of the first drop are described as (1) to (4), and first to fourth potential difference changes in the ejection waveform of the second drop are described as (21) to (24). The reference point of the phase of the ejection waveform of the first drop is (0), and the reference point of the phase of the ejection waveform of the second drop is (0″). Here, the reference point (0) of the phase of the ejection waveform of the first drop is an intermediate point between (2) and (3) of the potential difference change, and the reference point (0″) of the phase of the ejection waveform of the second drop is an intermediate point between (22) and (23) of the potential difference change. A voltage drop time tf in the drawing is substantially the same as a voltage rise time tr. In addition, amounts of potential difference change in (1) and (2) and amounts of potential difference change in (21) and (22) (i.e., change amounts in heights in FIG. 6) are substantially the same, and amounts of potential difference change in (3) and (4) and amounts of potential difference change in (23) and (24) are also substantially the same.

First, the main acoustic vibration of the ejection waveform of FIG. 6 will be described. In the ejection waveform by which the first drop is ejected in FIG. 6, if the potential difference change is performed and an intermediate voltage for expanding the pressure chamber 46 is input as shown in (1), the pressure chamber 46 is expanded with the potential difference of (1), and the pressure chamber 46 is depressurized. The vibration generated accordingly is a vibration whose phase is advanced by −π+(Dp21+Tm21)/2*(π/AL). Further, if the potential difference change shown in (2) is performed, in (2), the vibration is advanced in phase by −π+(Dp21−Tm21)/2*(π/AL). The combined wave of (1) and (2) is a vibration whose phase is advanced by −π+Dp21/2*(π/AL).

The potential difference changes (3) and (4) for contraction of the pressure chamber 46 are opposite changes for the potential difference to the potential difference changes (1) and (2) for expansion, and the pressure chamber 46 contracts and pressurizes the inside of the pressure chamber 46. Therefore, (3) is a vibration whose phase is advanced by −(Dp21−Tm21)/2*(π/AL). In addition, (4) can be considered as a vibration whose phase is advanced by −(Dp21+Tm21)/2*(π/AL). Therefore, the combined wave of (3) and (4) is a vibration whose phase is advanced by −Dp21/2*(π/AL).

Here, assuming the combined wave of (1), (2), (3), and (4) at the time point (0), the combined wave of (1), (2), (3), and (4) is a vibration whose phase is advanced by −π/2.

Next, the main acoustic vibration of the ejection waveform of the second drop in FIG. 6 will be described. If the potential difference change is performed and the intermediate voltage for expanding the pressure chamber 46 is input as shown in (21), the pressure chamber 46 is expanded by the potential difference of (21) and the inside of the pressure chamber 46 is depressurized, and thus when the ejection waveform width of the second drop is Dp22, the vibration is advanced in phase by −π+(Dp22+Tm22)/2*(π/AL). Further, when the potential difference change shown in (22) is performed, in (22), it can be considered that the vibration is advanced in phase by −π+(Dp22−Tm22)/2*(π/AL). Therefore, the combined wave of (21) and (22) is a vibration whose phase is advanced by −π+Dp22/2*(π/AL).

The potential difference changes (23) and (24) for contraction of the pressure chamber 46 are opposite changes for the potential difference to the potential difference changes (21) and (22) for expansion, and the pressure chamber 46 contracts and pressurizes the inside of the pressure chamber 46. Therefore, (23) is a vibration whose phase is advanced by −(Dp22−Tm22)/2*(π/AL). In addition, (24) is a vibration whose phase is advanced by −(Dp22+Tm22)/2*(π/AL). Therefore, the combined wave of (23) and (24) is a vibration whose phase is advanced by −Dp22/2*(π/AL).

Here, assuming the combined wave of (21), (22), (23), and (24) at the time point (0″), the combined wave of (21), (22), (23), and (24) is a vibration whose phase is advanced by −π/2.

Therefore, when the phase difference between (0) and (0″) is set to an even multiple of π (AL in the case of the time interval), the combined wave of (1), (2), (3), and (4) and the combined wave of (21), (22), (23), and (24) have the same phase and strengthen each other. In the example of FIG. 6, the time difference (or the time interval) between (0) and (0″) is 2AL. Further, by reducing the time width Dp22 of (21) and (23), the amplitude of the combined wave (i.e., the ejection waveform of the second drop) of (21), (22), (23), and (24) can be adjusted. Therefore, it is possible to adjust the ejection speed of the second drop ejected by strengthening the residual vibration due to the combined wave of (1), (2), (3), and (4) and the combined wave of (21), (22), (23), and (24). As described above, in the multi-drop drive waveform in which the liquid ejection head 1 continuously ejects a plurality of ink droplets, by adjusting Dp in the ejection waveform after any of the ejection waveforms, it is possible to adjust the ejection speed of the ink to be ejected later to be equal to or higher than the ejection speed of the previously ejected droplets.

However, in the drive waveform according to the comparative example shown in FIG. 6, waveform widths of Dp21 and Dp22 may be significantly different from each other due to a viscosity of the ink or a flow path resistance of an ink supply path to each nozzle 51. When driving the liquid ejection head 1 in which the main acoustic vibration frequencies of the plurality of pressure chambers 46 are greatly different due to manufacturing variations or the like in the drive waveforms in which the waveform widths of Dp21 and Dp22 are greatly different, the printing quality may deteriorate.

The liquid ejection head 1 according to an embodiment performs gradation expression by the number of continuously ejected droplets. Here, if there are a plurality of nozzles 51 that eject the same number of droplets, the same drive waveform is input to the plurality of piezoelectric pillars 21 that change the volumes of the plurality of pressure chambers 46 communicating with the plurality of nozzles 51. Meanwhile, the main acoustic vibration frequencies of the plurality of pressure chambers 46 are not necessarily the same due to manufacturing variations or the like. For example, a drive waveform for driving the inkjet head in which a maximum value of the half cycle AL of the main acoustic vibration frequencies of the plurality of pressure chambers 46 is 3.5 μs, a minimum value is 2.5 μs, and an average value is 3.0 μs will be described below.

AL of the plurality of pressure chambers 46 can be checked by individually inputting a rectangular wave to the piezoelectric pillar 21 that changes the volume of each pressure chamber 46 and measuring the speed of the droplets ejected from the nozzle 51 at that time. For example, when the speed of the droplet ejected is measured while changing the time width Dp of the rectangular wave and the ejection speed of the droplet is maximized when the time width Dp of the rectangular wave is 3.0 μs, 3.0 μs can be considered as AL of the corresponding pressure chamber 46.

Next, the characteristics of the drive waveform in the related art will be described. For example, when printing is performed by ejecting droplets from the liquid ejection head 1 while conveying a medium (for example, the sheet P) to be printed, it is necessary to adjust the speed of the droplets of each volume so that a landing position of the droplets on the medium does not change even if the volume of the droplets ejected from the nozzles 51 changes.

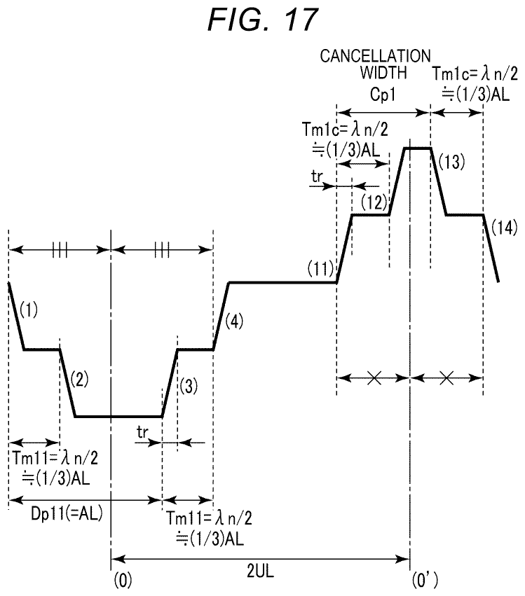

FIG. 17 shows an example of a drive waveform which is a 1-drop waveform for ejecting one drop. As shown in FIG. 17, the time width Dp11 of the ejection waveform is Dp11=AL. A center-to-center distance (a time interval between the centers) of the ejection waveform and the cancel waveform is set to 2 UL=2AL. Further, the wavelength λn of the parasitic vibration is the wavelength of the third harmonic of the main acoustic vibration, and Tm11=λn/2 (=UL/3). Further, the waveform width Dp of the ejection waveform by which each droplet of the drive waveform (n-drop waveform) by which a plurality of droplets are continuously ejected is ejected is set to 1AL for either the ejection waveform of the first droplet or the ejection waveform of a last droplet, and the waveform width Dp of the ejection waveform of other droplets is set to be smaller (Dp<AL) or larger (Dp>AL) than 1AL. Accordingly, the speed of the droplets when the droplets are continuously ejected is adjusted to a speed close to the ejection speed of one drop. For example, in the example of FIG. 6, the waveform width Dp21 of the ejection waveform of the leading droplet is 1AL, and the waveform width Dp22 of the ejection waveform of other droplets is smaller than 1AL. When droplets are continuously ejected, since a residual vibration of the pressure chamber 46 is generated by ejecting droplets first, the ejection speed of the subsequent droplet increases by ejecting the next droplet according to the phase of the residual vibration. In the case of one drop, since an increase in speed due to the residual vibration cannot be expected, the waveform width Dp11 of the ejection waveform of one drop is set to 1AL, and the ejection waveform width is adjusted when continuously ejecting droplets.

In addition, the wavelength λn of the parasitic vibration may vary similarly to the half cycle AL of the main acoustic vibration frequency. In the example, in order to weaken the parasitic vibration in more pressure chambers 46, it is assumed here that the average λn/2 is 1 μs and Tm11 is adjusted to the average λn/2.

For example, as shown in FIG. 6, in the pressure chamber 46 in which AL is approximately 3.0 μs among the plurality of pressure chambers 46, the drive waveform for continuously ejecting two drops is adjusted, and a 2-drop waveform is set to Dp21=3.0 μs, UL=3.0 μs, Dp22=2.1 μs, Cp=1.5 μs, and Tm21=Tm22=1.0 μs (=UL/3). In this case, it is assumed that the speed of the ejection droplet of the second drop of the 2-drop waveform is higher than the speed of the ejection droplet of the first drop of the 2-drop waveform.

In the 2-drop waveform, a center-to-center distance (a time interval between the centers) 2 UL between the ejection waveform of Dp21 and the ejection waveform of Dp22 is set to be twice AL of the pressure chamber 46 in order to match the phases of the residual vibration generated by the ejection waveform of Dp21 and the ejection waveform of Dp22. Further, even if the waveform width of Dp22 is smaller than AL of the pressure chamber 46, the speed of the ejection droplet of the second drop of the 2-drop waveform is higher than the speed of the ejection droplet of the first drop of the 2-drop waveform.

Here, the 2-drop waveform is input to the piezoelectric pillar 21 that changes the volume of the pressure chamber 46 in which AL is the maximum value of 3.5 μs among the plurality of pressure chambers 46. In this case, in addition to the increase in the difference between the waveform width of Dp22 and AL of the pressure chamber 46, a difference between the center-to-center distance 2 UL between the ejection waveform of Dp21 and the ejection waveform of Dp22 and the distance 2AL of the pressure chamber 46 increases. Therefore, there is a concern that the speed of the ejection droplet of the second drop is lower than the speed of the ejection droplet of the first drop of the 2-drop waveform. When the timing at which the ejection droplet of the second drop lands on the medium is later than the timing at which the ejection droplet of the first drop lands on the medium, which leads to a deterioration in printing quality.

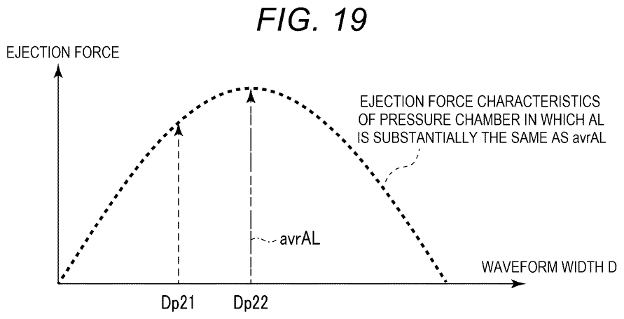

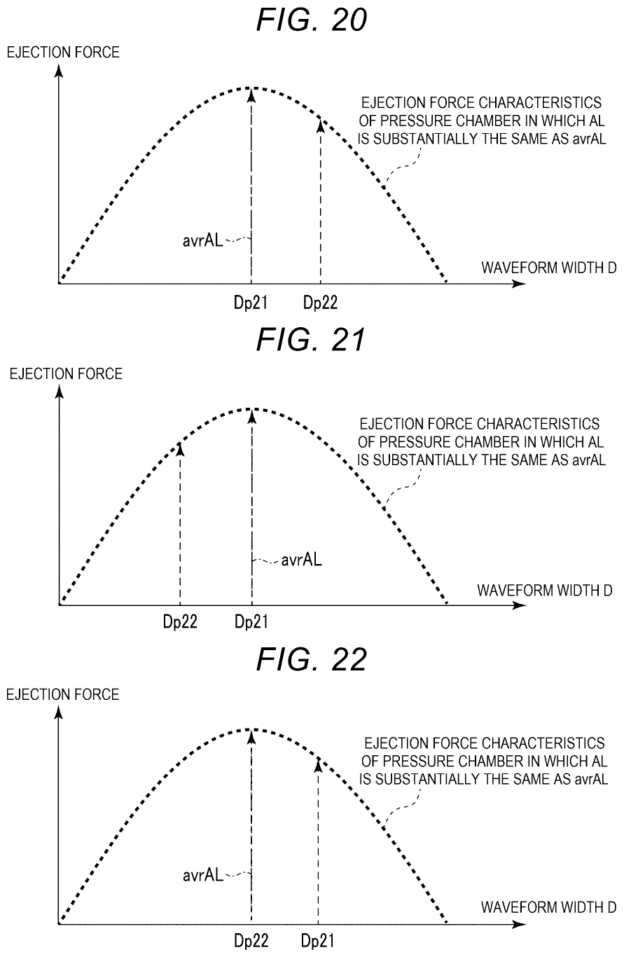

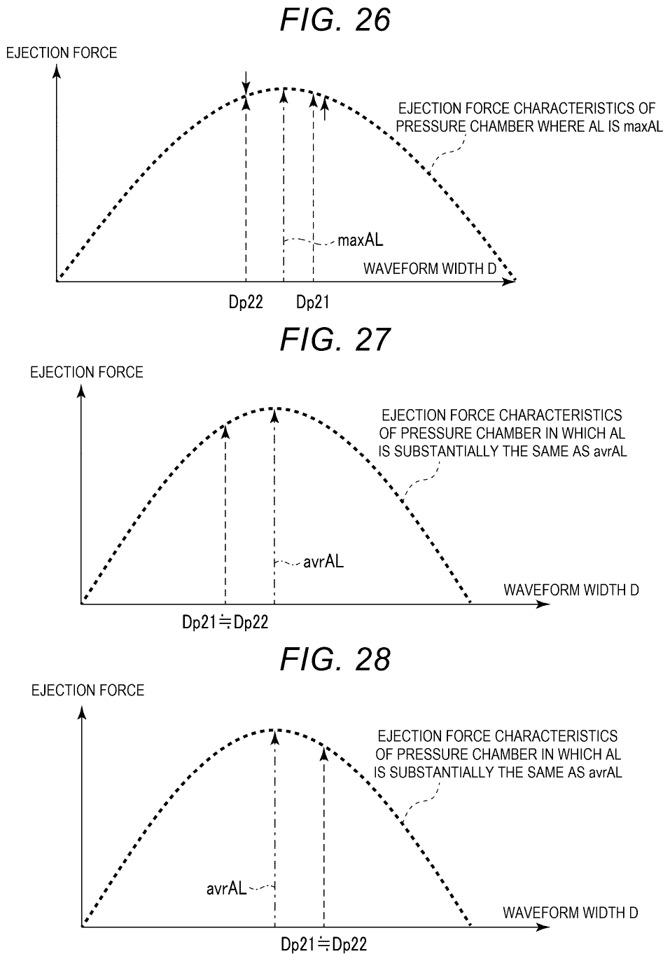

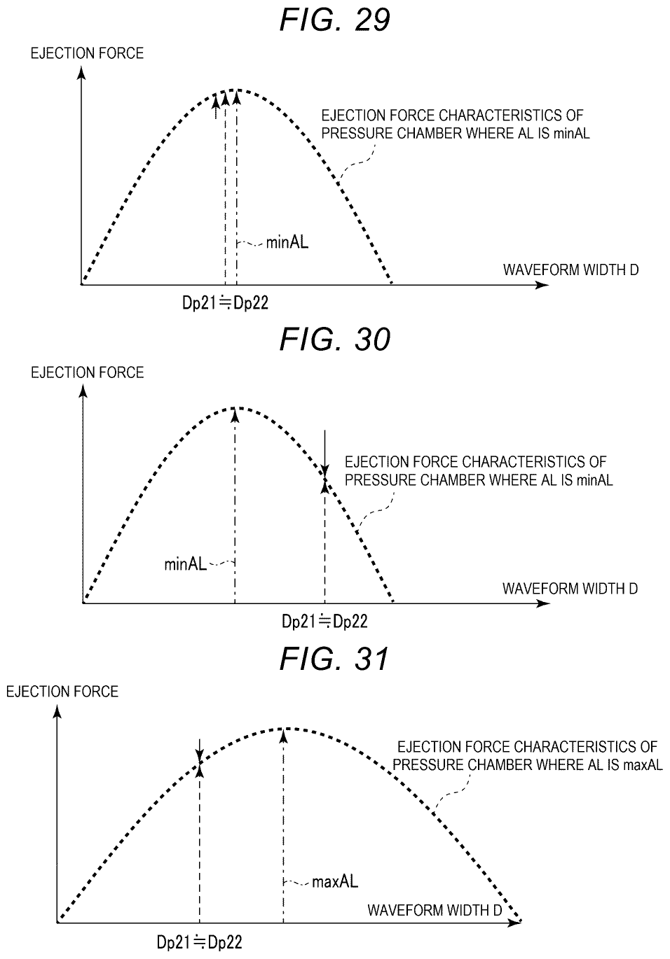

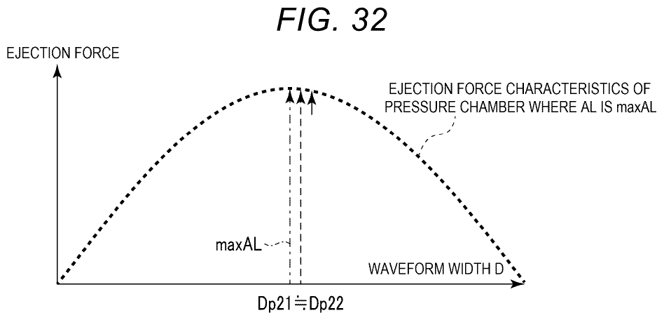

For example, FIGS. 19 to 32 show the relation between the waveform width and the ejection force based on the conditions of the time width Dp of the leading droplet and the subsequent droplet. In FIGS. 19 to 32, the horizontal axis represents the waveform width of the ejection waveform, the vertical axis represents the ejection force with respect to the waveform width when there is no residual vibration, and ejection force characteristics of the pressure chamber 46 are schematically shown by broken lines. FIGS. 19 to 26 show an example in which the time width Dp21 of the ejection waveform of the leading droplet and the time width Dp22 of the ejection waveform of the subsequent droplet are different (Dp21 #Dp22), and FIGS. 27 to 32 show an example in which Dp21 of the leading droplet and Dp22 of the subsequent droplet are the same or substantially the same (Dp21-Dp22). Here, avrAL is an average value of AL of the plurality of pressure chambers 46 to which the same drive waveform is input. minAL is a minimum value of AL of the plurality of pressure chambers 46 to which the same drive waveform is input. maxAL is a maximum value of AL of the plurality of pressure chambers 46 to which the same drive waveform is input. In FIGS. 19 to 22 and FIGS. 27 and 28, an upwardly convex broken line indicates the ejection force characteristics in the pressure chamber 46 in which AL is substantially the same as avrAL.

FIG. 21 shows the relation between the waveform width and the ejection force when Dp21 has the same time width as avrAL and Dp22 has a time width smaller than avrAL in the waveform of FIG. 6. In FIG. 21, the ejection force of Dp22 is slightly smaller than that of Dp21, but in the waveform of FIG. 6, the residual vibration generated by Dp21 strengthens with Dp22, so that the droplet speed ejected by Dp22 becomes equal to or higher than the droplet speed ejected by Dp21.

FIG. 25 is a diagram showing a relation between the waveform width and the ejection force when the pressure chamber 46 in which AL is maxAL is driven in the drive waveform as shown in FIG. 6 having the waveform widths of Dp21 and Dp22 shown in FIG. 21. Since the waveform width of Dp21 in FIG. 25 is avrAL, the ejection force is near the peak of the ejection force characteristics of the pressure chamber 46, and the change in the ejection force is relatively small. On the other hand, since the waveform width of Dp22 in FIG. 25 is considerably smaller than that of avrAL, the change in the ejection force due to the extension of AL of the pressure chamber 46 is large. In addition, since the difference between the center-to-center distance 2 UL of the ejection waveform of Dp21 and the ejection waveform of Dp22 and 2AL (=2*maxAL) of the pressure chamber 46 is large, in FIG. 25, the ejection force is reduced in both Dp21 and Dp22 as compared with FIG. 21, but the reduction in Dp22 is larger. Therefore, even if Dp22 and the residual vibration strengthen each other, there is a possibility that the droplet speed ejected by Dp22 becomes lower than the droplet speed ejected by Dp21.

Next, the drive waveform for continuously ejecting two drops is adjusted in the pressure chamber 46 in which AL is approximately 3.0 μs among the plurality of pressure chambers 46, and the 2-drop waveform is set to Dp21=2.1 μs, UL=3.0 μs, Dp22=3.0 μs, Cp=1.5 μs, and Tm21=Tm22=1.0 μs (=UL/3). In this case, a case in which the speed of the ejection droplet of the second drop of the 2-drop waveform is higher than the speed of the ejection droplet of the first drop of the 2-drop waveform is considered.

In order to match the phases of the residual vibration generated by the 2-drop waveform and the ejection waveform of Dp21 and the ejection waveform of Dp22, the center-to-center distance 2 UL between the ejection waveform of Dp21 and the ejection waveform of Dp22 is set to be twice AL of the pressure chamber 46. Therefore, the speed of the ejection droplet of the second drop of the 2-drop waveform is higher than the speed of the ejection droplet of the first drop of the 2-drop waveform.

Here, the 2-drop waveform is input to the piezoelectric pillar 21 that changes the volume of the pressure chamber 46 in which AL is the minimum value of 2.5 μs among the plurality of pressure chambers 46. In this case, since the difference between the waveform width of Dp21 and AL of the pressure chamber 46 decreases, the ejection speed of the first drop increases, whereas the difference between the waveform width of Dp22 and AL of the pressure chamber 46 increases, and the difference between the center-to-center distance 2 UL between the ejection waveform of Dp21 and the ejection waveform of Dp22 and the center-to-center distance 2AL of the pressure chamber 46 increases. Therefore, there is a concern that the speed of the ejection droplet of the second drop is lower than the speed of the ejection droplet of the first drop of the 2-drop waveform. Therefore, the timing at which the ejection droplet of the second drop lands on the medium is later than the timing at which the ejection droplet of the first drop lands on the medium, which leads to a deterioration in printing quality.

FIG. 19 shows the relation between the waveform width and the ejection force when Dp22 has the same time width as avrAL and Dp21 has a time width smaller than avrAL. As shown in FIG. 19, Dp22 has a larger ejection force than Dp21. In addition, since the residual vibration generated by Dp21 strengthens with Dp22, the droplet speed ejected by Dp22 becomes higher than the droplet speed ejected by Dp21.

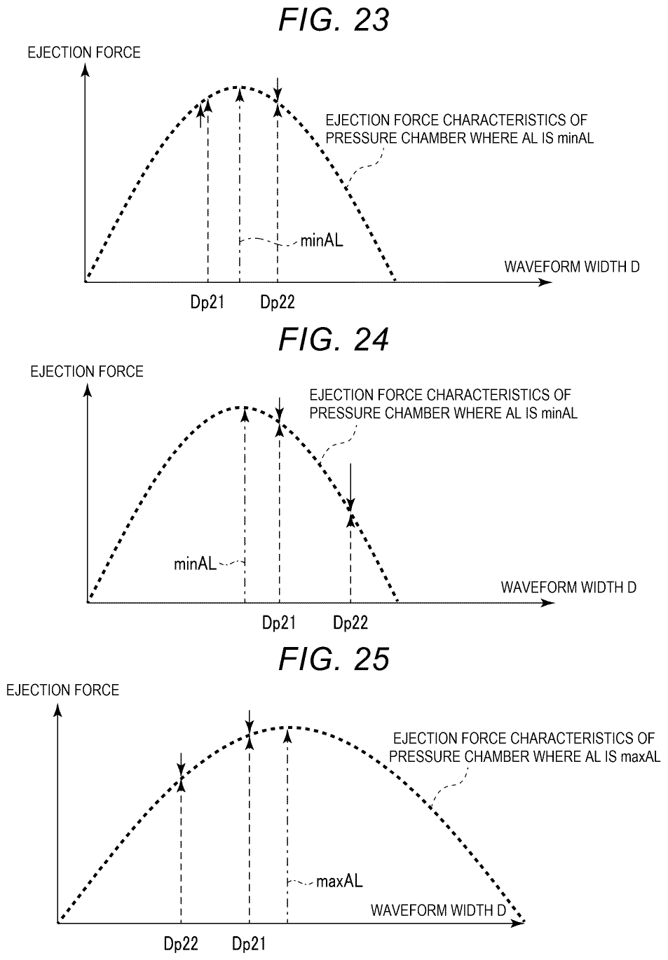

FIG. 23 shows the relation between the waveform width and the ejection force when a drive waveform in which Dp22 has the same time width as avrAL and Dp21 has a time width smaller than avrAL is input to the pressure chamber 46 in which AL of the pressure chamber 46 is minAL.

As shown in FIG. 23, since Dp21 has a waveform width closer to the value of minAL than Dp22, the ejection force of Dp21 increases. In addition, since the difference between the center-to-center distance 2 UL between the ejection waveform of Dp21 and the ejection waveform of Dp22 and 2AL (2*minAL) of the pressure chamber 46 becomes large, even if Dp22 and the residual vibration strengthen each other, there is a possibility that the droplet speed ejected by Dp22 is lower than the droplet speed ejected by Dp21.

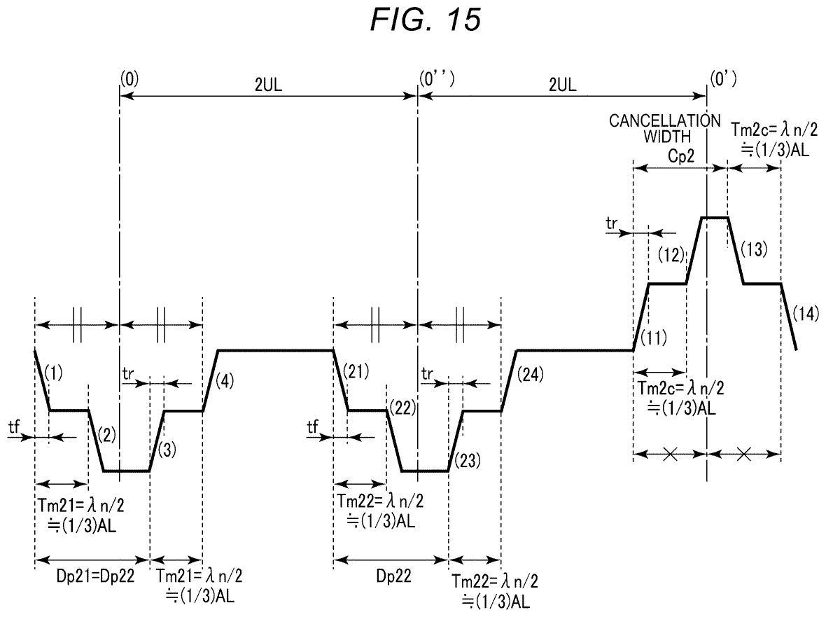

Next, a drive waveform according to an embodiment will be described with reference to FIG. 15. In the drive waveform, the time width Dp21 of the ejection waveform of the first drop (i.e., previous ejection) and the time width Dp22 of the ejection waveform of the second drop (i.e., subsequent ejection) are the same (here, the same includes substantially the same), and the interval between the ejection waveforms coincides with the cycle for strengthening the residual vibration of the liquid in the pressure chamber 46 generated by the ejection waveform generated earlier and the vibration of the liquid in the pressure chamber 46 generated by the ejection waveform generated subsequently. For example, Dp21 and Dp22 are made different from 1AL. For example, among the plurality of pressure chambers 46, in a pressure chamber 46 where AL is approximately 3.0 μs, if the drive waveform for continuously ejecting two drops as shown in FIG. 15 is adjusted and the 2-drop waveform is Dp21=Dp22=2.4 μs, UL=3.0 μs, Cp=1.5 μs, and Tm21=Tm22=1.0 μs (=UL/3), the speed of the ejection droplet of the second drop of the 2-drop waveform is higher than the speed of the ejection droplet of the first drop of the 2-drop waveform, and the speed of the ejection droplet of the 1-drop waveform is a speed close to the droplet speed of any of the ejection droplets of the 2-drop waveform. More preferably, Dp21=Dp22 is adjusted so that the speed of a combined droplet is substantially the same as the ejection speed of the droplet of the 1-drop waveform.

When the waveform widths of Dp21 and Dp22 are the same or substantially the same as in FIG. 15, the pressures applied to the liquid in the pressure chamber 46 by the ejection waveforms of Dp21 and Dp22 are the same or substantially the same. In addition, by setting a center-to-center interval between the ejection waveform of Dp21 and the ejection waveform of Dp22 to be substantially the same as 2AL, the residual vibration of the pressure chamber 46 generated by Dp21 and the pressure applied to the liquid in the pressure chamber 46 by Dp22 strengthen each other. Therefore, the speed of the droplet ejected by Dp22 is usually higher than that of the droplet ejected by Dp21.

FIGS. 27, 29, and 31 show the relation between the waveform width and the ejection force when Dp21 and Dp22 in the waveform of FIG. 15 have a time width smaller than minAL. In FIGS. 27, 29, and 31, the ejection forces of Dp22 and Dp21 are equivalent. In the waveform of FIG. 15, the residual vibration generated by Dp21 strengthens with Dp22, so that the droplet speed ejected by Dp22 becomes equal to or higher than the droplet speed ejected by Dp21.

Next, the conditions under which the residual vibration of the pressure chamber 46 generated by Dp21 and the pressure applied to the liquid in the pressure chamber 46 by Dp22 strengthen each other will be specifically described with reference to FIG. 15. In this example, the waveform widths of the ejection waveform of the second drop and the ejection waveform of the first drop are substantially the same. In order to make the speed of the ejection droplet of the 1-drop waveform and the speed of the ejection droplet of the 2-drop waveform substantially the same, Dp21 and Dp22 are set to be smaller than the average value 3.0 μs of the half cycle AL of the main acoustic vibration frequency of the plurality of pressure chambers 46.

Here, when the 1-drop waveform is the waveform as shown in FIG. 17, the residual vibrations are not strengthened. Therefore, when a voltage height or amplitude of the ejection waveform is the same between the 1-drop waveform and a plural-drop waveform, in order to obtain the same ejection speed as that of the plural-drop waveform, it is necessary to set an ejection waveform width with a large ejection force in the 1-drop waveform. For example, the ejection waveform width of one drop is desirably set between minAL and maxAL to increase the ejection force. In this case, for example, a case in which the waveform width of each ejection waveform of a plurality of drops is set to minAL is considered. In the pressure chamber 46 in which AL is minAL, the ejection force of the plural-drop waveform in which an ejection width is minAL is larger than that of the 1-drop waveform in which the ejection width is the average AL.

In addition, since the residual vibrations are strengthened, the ejection speed of a plurality of drops of droplets may be extremely higher than that of a droplet of one drop. When the waveform width of each ejection waveform of the plurality of drops is set between minAL and maxAL, the same concern occurs in any pressure chamber 46 in which AL is between minAL and maxAL. Therefore, it is desirable to set the waveform width of each ejection waveform of the plurality of drops smaller than minAL or larger than maxAL.

Here, for convenience of description, in FIG. 15, the first to fourth potential difference changes in the ejection waveform of the first drop are described as (1) to (4), and the first to fourth potential difference changes in the ejection waveform of the second drop are described as (21) to (24). The reference point of the phase of the ejection waveform of the first drop is (0), and the reference point of the phase of the ejection waveform of the second drop is (0″). Here, the reference point (0) of the phase of the ejection waveform of the first drop is an intermediate point between (2) and (3) of the potential difference change, and the reference point (0″) of the phase of the ejection waveform of the second drop is an intermediate point between (22) and (23) of the potential difference change. The voltage drop time tf in FIG. 15 is substantially the same as the voltage rise time tr in FIG. 15. The amount in the potential difference change in (1), (2), (21), and (22) and the amount in the potential difference change in (3), (4), (23), and (24) (the change amount in the height in FIG. 15) are substantially the same.

The main acoustic vibration of the ejection waveform of the first drop shown in FIG. 15 will be described. As shown in FIG. 15, in the ejection waveform by which the first drop is ejected, if the potential difference change is performed and the voltage for expanding the pressure chamber 46 is input as shown in (1), the pressure chamber 46 is expanded with the potential difference of (1), and the pressure chamber 46 is depressurized. The vibration generated accordingly is a vibration whose phase is advanced by −π+(Dp21+Tm21)/2*(π/AL). Further, if the potential difference change shown in (2) is performed, in (2), the vibration is advanced in phase by −π+ (Dp21−Tm21)/2*(π/AL). The combined wave of (1) and (2) is a vibration whose phase is advanced by −π+Dp21/2*(π/AL).

The potential difference changes (3) and (4) for contraction of the pressure chamber 46 are opposite changes for the potential difference to the potential difference changes (1) and (2) for expansion, and the pressure chamber 46 contracts and pressurizes the inside of the pressure chamber 46. Therefore, (3) is a vibration whose phase is advanced by −(Dp21−Tm21)/2*(π/AL). In addition, (4) can be considered as a vibration whose phase is advanced by −(Dp21+Tm21)/2*(π/AL). Therefore, the combined wave of (3) and (4) is a vibration whose phase is advanced by −Dp21/2*(π/AL).

Here, assuming the combined wave of (1), (2), (3), and (4) at the time point (0), the combined wave of (1), (2), (3), and (4) is a vibration whose phase is advanced by −π/2.

Next, the main acoustic vibration of the ejection waveform of the second drop in FIG. 15 will be described. If the potential difference change is performed and the voltage for expanding the pressure chamber 46 is input as shown in (21), the pressure chamber 46 is expanded by the potential difference of (21) and the inside of the pressure chamber 46 is depressurized, and thus when the ejection waveform width of the second drop is Dp22, the vibration is advanced in phase by −π+(Dp22+Tm22)/2*(π/AL). Further, when the potential difference change shown in (22) is performed, in (22), it can be considered that the vibration is advanced in phase by −π+(Dp22−Tm22)/2*(π/AL). Therefore, the combined wave of (21) and (22) is a vibration whose phase is advanced by −π+Dp22/2*(π/AL).

The potential difference changes (23) and (24) for contraction of the pressure chamber 46 are opposite changes for the potential difference to the potential difference changes (21) and (22) for expansion, and the pressure chamber 46 contracts and pressurizes the inside of the pressure chamber 46. Therefore, (23) is a vibration whose phase is advanced by −(Dp22−Tm22)/2*(π/AL). In addition, (24) is a vibration whose phase is advanced by −(Dp22+Tm22)/2*(π/AL). Therefore, the combined wave of (23) and (24) is a vibration whose phase is advanced by −Dp22/2*(π/AL).

Here, assuming the combined wave of (21), (22), (23), and (24) at the time point (0″), the combined wave of (21), (22), (23), and (24) is a vibration whose phase is advanced by −π/2.

Therefore, when the phase difference between (0) and (0″) is set to an even multiple of π (AL in the case of the time interval), the combined wave of (1), (2), (3), and (4) and the combined wave of (21), (22), (23), and (24) have the same phase and strengthen each other. In the shown example, the time difference (the time interval) between (0) and (0″) is 2AL.

Here, the condition of the time difference (or the time interval) between (0) and (0″) in which the amplitudes of the combined wave of (1), (2), (3), and (4) and the combined wave of (21), (22), (23), and (24) are strengthened is considered. If the time difference 2 UL between (0) and (0″) is larger than 1.5AL and less than 2.5AL, the combined wave of (1), (2), (3), and (4) and the combined wave of (21), (22), (23), and (24) strengthen each other.

Further, in the liquid ejection head 1, the half cycles AL of the main acoustic vibration frequencies of the plurality of pressure chambers 46 are not the same due to manufacturing variations. Here, the maximum value of the half cycle AL of the main acoustic vibration frequency of the plurality of pressure chambers 46 is maxAL, and the minimum value is minAL. In this case, the value when 1.5AL is the largest in the plurality of pressure chambers 46 is 1.5 maxAL, and the value when 2.5AL is the smallest is 2.5 minAL. Therefore, 2 UL satisfying 1.5AL≤1.5 maxAL<2 UL<2.5 minAL≤2.5AL may be set to the time difference between (0) and (0″). Therefore, when the time difference 2 UL between (0) and (0″) of the 2-drop waveform shown in FIG. 15 is set to be larger than 1.5 maxAL and smaller than 2.5 minAL, the phase difference between the combined wave of (1), (2), (3), and (4) and the combined wave of (21), (22), (23), and (24) is less than ±90 degrees in all of the plurality of pressure chambers 46, and the combined wave of (1), (2), (3), and (4) and the combined wave of (21), (22), (23), and (24) strengthen each other.

Since the time widths Dp21 of (1) and (3) and the time widths Dp22 of (21) and (23) are substantially the same, even if the half cycle AL of the main acoustic vibration frequency of the pressure chamber 46 is different from the waveform UL, the pressure applied to the corresponding liquid in the pressure chamber 46 by the ejection waveform of the time widths Dp21 and Dp22 is the same. In addition, the ejection speed of the second drop ejected by the strengthening of the residual vibration due to the combined wave of (1), (2), (3), and (4) and the combined wave of (21), (22), (23), and (24) is higher than the ejection speed of the first drop. As described above, by the multi-drop drive waveform shown in FIG. 15 in which a plurality of ink droplets are continuously ejected, in all of the plurality of pressure chambers 46, it is possible to adjust the ejection speed of the ink ejected later by the residual vibration generated by the previous ejection waveform to be equal to or higher than the ejection speed of the previously ejected droplets.

The time interval between (1) and (2) for depressurizing the pressure chamber 46 is Tm21, and the time interval between (3) and (4) for pressurizing the pressure chamber 46 is also Tm21. Therefore, when Tm21 is set under the condition of Math. 4 as described above, the parasitic vibrations of (1) and (2) cancel out each other, and the parasitic vibrations of (3) and (4) cancel out each other. Further, the time interval between (21) and (22) for depressurizing the pressure chamber 46 is Tm22, and the time interval between (23) and (24) for pressurizing the pressure chamber 46 is also Tm22. Therefore, when Tm22 is set under the condition of Math. 4 as described above, the parasitic vibrations of (21) and (22) cancel out each other, and the parasitic vibrations of (23) and (24) cancel out each other.

Although it is described that the ejection speed of the ink ejected later by the residual vibration generated by the previous ejection waveform is adjusted to be equal to or higher than the ejection speed of the previously ejected droplets, it is also possible to adjust the ejection speed to be equal to or higher than the ejection speed of the droplet ejected before by shortening Tm of the ejection waveform input later than Tm of the previous ejection waveform. This is because, as Tm is shorter, for example, as shown in FIG. 7, strengthening of the main acoustic vibrations by the rising waveform and the falling waveform increases. Specifically, in the case of the drive waveform as shown in FIG. 15, the droplet speed of the second drop can be made higher than the droplet speed of the first drop by making the time width of Tm22 shorter than Tm21. If the time widths of Tm21 and Tm22 are set within the range of the condition of Math. 4 as described above, the parasitic vibration can also be weakened.

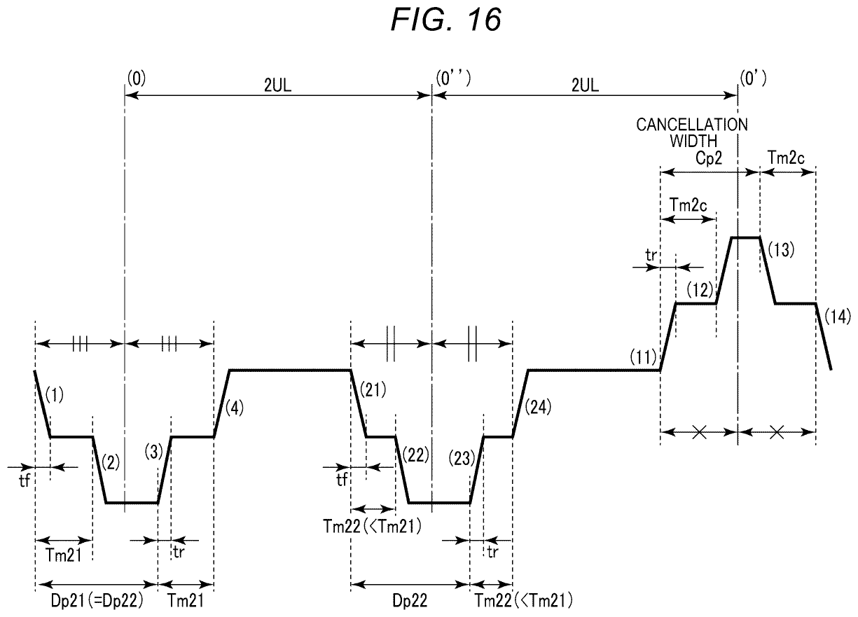

For example, a case in which the cycle λn of the parasitic vibration is a third harmonic of the main acoustic vibration is considered. Here, λn is 2AL/3, and AL=3.0 μs. When λn is substituted into Math. 4 in the case of k=1, 2/3 μs≤Tm≤4/3 μs is obtained. For example, in the example of another embodiment in FIG. 16, when Tm21=1.3 μs and Tm22=0.7 μs, the drive waveform in which Tm satisfying Math. 4 is set is obtained.

In the liquid ejection head 1, the cycles λn of the parasitic vibrations of the plurality of pressure chambers 46 may not be the same due to manufacturing variations. Here, a maximum value of the cycles λn of the parasitic vibrations of the plurality of pressure chambers 46 is maxλn, and a minimum value is minλn. In this case, in the plurality of pressure chambers 46, a lower limit of Math. 4 is largest when it is (k/2−1/6) maxλn, and an upper limit of Math. 4 is smallest when it is (k/2+1/6)minλn. Therefore, (k/2−1/6)maxλn≤Tm≤(k/2+1/6)minλn (Math. 6) is obtained. Here, k is an odd number of 1 or more.

When Tm is set within a range in which Math. 6 is satisfied, the parasitic vibration can be weakened in all of the plurality of pressure chambers 46.

Here, a case in which the cycle λn of the parasitic vibration is a third harmonic of the main acoustic vibration is considered. minλn is set to be 2*minAL/3=5/3 μs, and maxλn is set to be 2*maxAL/3=7/3 μs. In the case of k=1, when minλn and maxλn are substituted into Math. 6, 7/9 μs≤Tm≤10/9 μs is obtained. When Tm is set within the above range, the parasitic vibration can be weakened in all of the plurality of pressure chambers 46. For example, in FIG. 16, if Tm21=1.1 μs and Tm22=0.8 μs, a drive waveform in which Tm is set is obtained in which Math. 6 is satisfied.

In one embodiment, the 1-drop waveform shown in FIG. 17 has the same times tf and tr and the same voltage height of the ejection waveform as the 2-drop waveform shown in FIG. 15, and the 1-drop waveform may be a waveform completely different from the 2-drop waveform. In this case, it is also necessary to reduce the difference in droplet speed ejected from the same nozzle between the 1-drop waveform and the 2-drop waveform in order to maintain the printing quality. In this case, the time width Dp21 (=Dp22) of the 2-drop waveform shown in FIG. 15 may be adjusted so that the speed of each droplet of the 2-drop waveform or the speed of the droplet obtained by combining the droplets ejected by Dp21 and Dp22 shown in FIG. 17 is close to the droplet speed of a waveform different from the 1-drop waveform.

Even when it is desirable to set Dp21 and Dp22 to different values in order to finely adjust each droplet speed of the 2-drop waveform, it is desirable to set Dp21 and Dp22 to values as close as possible so that the pressure on the liquid in the pressure chamber 46 by Dp21 and Dp22 becomes close. For example, the time difference between Dp21 and Dp22 is desirably a minimum time difference other than a time difference of zero that can be set in the drive circuit 70 that generates the drive waveform.

For example, if the 2-drop waveform is Dp21=Dp22=2.4 μs, Tm21=Tm22=1.0 μs, UL=3.0 μs, and Cp=1.5 μs, a speed of a combined droplet by the 2-drop waveform is higher than a speed of the ejection droplet of the 1-drop waveform, and if the 2-drop waveform is Dp21=Dp22=2.3 μs, Tm21=Tm22=1.0 μs, UL=3.0 μs, and Cp=1.5 μs, a speed of the combined droplet by the 2-drop waveform is lower than the speed of the ejection droplet of the 1-drop waveform.

In the drive circuit 70 of the corresponding liquid ejection head 1, when the values of Dp21 and Dp22 cannot be set to values between 2.3 μs and 2.4 μs, for example, Dp21=2.3 μs, Dp22=2.4 μs, Tm21=Tm22=1.0 μs, UL=3.0 μs, and Cp=1.5 μs may be set.

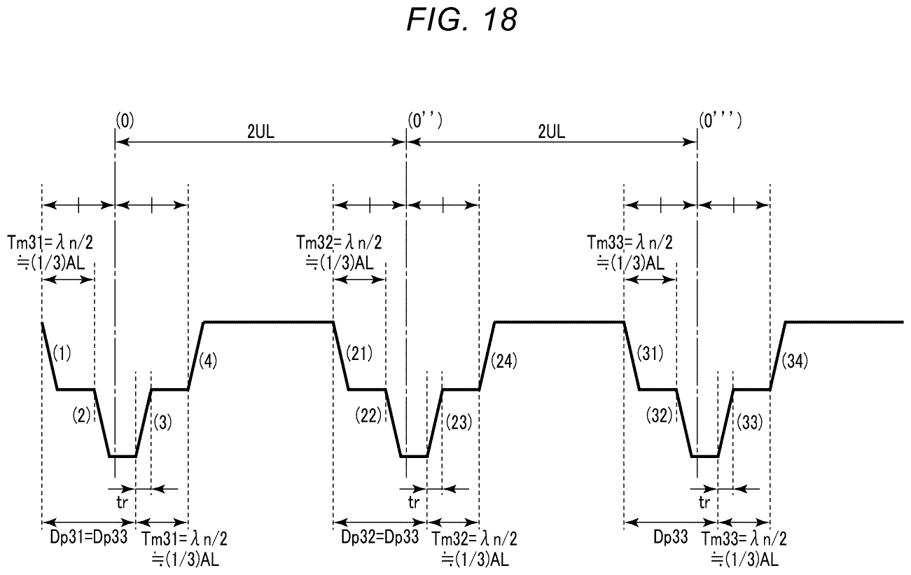

The multi-drop drive waveform by which a plurality of droplets of the liquid ejection head 1 are ejected is not limited to the 2-drop waveform, and may be an n-drop waveform by which a predetermined number n of droplets are ejected, such as a 3-drop waveform by which droplets of three drops or more are ejected. FIG. 18 shows an example of the 3-drop waveform by which three drops of droplets are ejected as a drive waveform according to another embodiment. In the example of the drive waveform in FIG. 18, the cancel waveform is omitted. As shown in FIG. 18, when the time difference between (0) and (0″) is set to be larger than 1.5 maxAL and smaller than 2.5 minAL, the phase difference between the combined wave of (1), (2), (3), and (4) and the combined wave of (21), (22), (23), and (24) is less than ±90 degrees in all of the plurality of pressure chambers 46. Accordingly, the combined wave of (1), (2), (3), and (4) and the combined wave of (21), (22), (23), and (24) strengthen each other.

As shown in FIG. 18, when the time difference between (0″) and (0″) is set to be larger than 1.5 maxAL and smaller than 2.5 minAL, the phase difference between the combined wave of (21), (22), (23), and (24) and the combined wave of (31), (32), (33), and (34) is less than +90 degrees in all of the plurality of pressure chambers 46. Accordingly, the combined wave of (21), (22), (23), and (24) and the combined wave of (31), (32), (33), and (34) strengthen each other. By setting Dp31 (=Dp32=Dp33) and adjusting the time width of Dp31 (=Dp32=Dp33), even if the half cycle AL of the main acoustic vibration frequency of the pressure chamber 46 is different from the waveform UL, the pressure applied to the corresponding liquid in the pressure chamber 46 by the ejection waveforms of the time widths of Dp31, Dp32, and Dp33 is the same. In addition, the ejection speed of the second drop ejected by the strengthening of the residual vibration due to the combined wave of (1), (2), (3), and (4) and the combined wave of (21), (22), (23), and (24) is higher than the ejection speed of the first drop. In addition, the ejection speed of the third drop ejected by strengthening the residual vibration due to the combined wave of (21), (22), (23), and (24) and the combined wave of (31), (32), (33), and (34) is higher than the ejection speed of the second drop.

As described above, by the multi-drop drive waveform (i.e., the n-drop waveform) in which a plurality of ink droplets are continuously ejected, in all of the plurality of pressure chambers 46, it is possible to adjust the ejection speed of the ink ejected later by the residual vibration generated by the previous ejection waveform to be equal to or higher than the ejection speed of the previously ejected droplets.

The time interval between (1) and (2) for depressurizing the pressure chamber 46 is Tm31, and the time interval between (3) and (4) for pressurizing the pressure chamber 46 is also Tm31. Therefore, when Tm31 is set under the condition of Math. 4 as described above, the parasitic vibrations of (1) and (2) cancel out each other, and the parasitic vibrations of (3) and (4) cancel out each other. Further, the time interval between (21) and (22) for depressurizing the pressure chamber 46 is Tm32, and the time interval between (23) and (24) for pressurizing the pressure chamber 46 is also Tm32. Therefore, when Tm32 is set under the condition of Math. 4 as described above, the parasitic vibrations of (21) and (22) cancel out each other, and the parasitic vibrations of (23) and (24) cancel out each other. Further, the time interval between (31) and (32) for depressurizing the pressure chamber 46 is Tm33, and the time interval between (33) and (34) for pressurizing the pressure chamber 46 is also Tm33. Therefore, when Tm33 is set under the condition of Math. 4 as described above, the parasitic vibrations of (31) and (32) cancel out each other, and the parasitic vibrations of (33) and (34) cancel out each other.

Although it is described so far that the ejection speed of the ink ejected later by the residual vibration generated by the previous ejection waveform is adjusted to be equal to or higher than the ejection speed of the previously ejected droplets, it is also possible to adjust the ejection speed to be equal to or higher than the ejection speed of the droplet ejected before by shortening Tm of the ejection waveform input later than Tm of the previous ejection waveform. This is because, as Tm is shorter, for example, the strengthening of the main acoustic vibrations by the rising waveform and the falling waveform shown in FIG. 7 increases. Specifically, in the case of the 3-drop waveform as shown in FIG. 18, the droplet speed of the second drop can be made higher than the droplet speed of the first drop by making the time width of Tm32 shorter than Tm31. By making the time width of Tm33 shorter than Tm32, the droplet speed of the third drop can be made higher than the droplet speed of the second drop. If the time widths of Tm31, Tm32, and Tm33 are set within the range of the condition of Math. 4, the parasitic vibration can also be weakened.

As shown in FIGS. 15 and 17, the 1-drop waveform and the 2-drop waveform are the same as the 3-drop waveform shown in FIG. 18 in the times of tf and tr and the voltage height of the ejection waveform, and the 1-drop waveform and the 2-drop waveform may be completely different waveforms from the 3-drop waveform. Even in this case, in order to maintain the printing quality, it is necessary to reduce the difference in droplet speed ejected from the same nozzle between the 1-drop waveform, the 2-drop waveform, and the 3-drop waveform. Here, it is assumed that the 1-drop waveform and the 2-drop waveform are adjusted to reduce the difference in droplet speed ejected from the same nozzle. The time width Dp31 (=Dp32=Dp33) of the 3-drop waveform in FIG. 18 may be adjusted so that the speed of each droplet of the 3-drop waveform or the speed of the droplet obtained by combining the droplets ejected by Dp31, Dp32, and Dp33 is close to the droplet speed of a waveform different from the 1-drop waveform in FIG. 17 or the 2-drop waveform in FIG. 15.

Even when it is desirable to set Dp31, Dp32, and Dp33 to different values in order to finely adjust each droplet speed of the 3-drop waveform, it is desirable to set Dp31, Dp32, and Dp33 to values as close as possible so that the pressures on the liquid in the pressure chamber 46 by Dp31, Dp32, and Dp33 become close. For example, the time difference between Dp31, Dp32, and Dp33 is desirably a minimum time difference other than the time difference of zero that can be set in the drive circuit 70 that generates the drive waveform.

For example, if the 3-drop waveform is Dp31=Dp32=Dp33=2.4 μs, Tm31=Tm32=Tm33=1.0 μs, UL=3.0 μs, and Cp=1.5 μs, the speed of the combined droplet by the 3-drop waveform is higher than the speed of the ejection droplet by the 1-drop waveform, and if the 3-drop waveform is Dp31=Dp32=Dp33=2.3 μs, Tm31=Tm32=Tm33=1.0 μs, UL=3.0 μs, and Cp=1.5 μs, the speed of the combined droplet by the 3-drop waveform is lower than the speed of the ejection droplet by the 1-drop waveform.

In the drive circuit 70 of the corresponding liquid ejection head 1, when the values of Dp31, Dp32, and Dp33 cannot be set to values between 2.4 μs and 2.3 μs, for example, Dp31=Dp32=2.3 μs, Dp33=2.4 μs, Tm31=Tm32=Tm33=1.0 μs, UL=3.0 μs, and Cp=1.5 μs are set. Alternatively, Dp31=2.3 μs, Dp32=Dp33=2.4 μs, Tm31=Tm32=Tm33=1.0 μs, UL=3.0 μs, and Cp=1.5 μs may be set.

In addition, even in the drive waveform (i.e., n-drop waveform) of a plurality of droplets different from the 2-drop waveform and the 3-drop waveform, when the reference point of the phase of the ejection waveform which is input first among the two continuous ejection waveforms is set to (0) and the reference point of the phase of the next ejection waveform is set to (0″), and the time difference between (0) and (0″) is set to be larger than 1.5 maxAL and smaller than 2.5 minAL, in all of the plurality of pressure chambers, all the ejection waveforms which are ejected after the second drop are strengthened with the residual vibration of the previous ejection waveform. In addition, by setting all the ejection waveform widths to Dpn1 (=Dpn2= . . . =Dpnn) and adjusting the time width of Dpn1 (=Dpn2= . . . =Dpnn), even if the half cycle AL of the main acoustic vibration frequency of the pressure chamber 46 is different from the waveform UL, the ejection waveforms having the time widths of Dpn1 to Dpnn apply the same pressure to the liquid in the corresponding pressure chamber 46. As described above, by the multi-drop drive waveform in which a plurality of ink droplets are continuously ejected, in all of the plurality of pressure chambers 46, it is possible to adjust the ejection speed of the ink ejected later by the residual vibration generated by the previous ejection waveform to be equal to or higher than the ejection speed of the previously ejected droplets.

In addition, if Tmn1 (=Tmn2= . . . =Tmnn) is set under the condition of Math. 4 as described above, the parasitic vibrations due to the first and last pressure changes of each Tm cancel out each other. In addition, by making Tm of an ejection waveform input later than Tm of the previous ejection waveform shorter, the speed of droplets ejected by any ejection waveform can be adjusted to be faster than the ejection speed of droplets ejected previously. This is because, as Tm is shorter, for example, the strengthening of the main acoustic vibrations by the rising waveform and the falling waveform shown in FIG. 7 increases. When any time of Tm among Tmn1 to Tmnn is made shorter than the previous Tm in order to adjust the ejection speed of the droplet, it is desirable to make the subsequent Tm equal to or shorter than the time of the any Tm in order to maintain the speed of the droplet or to increase the speed of the droplet according to the subsequent ejection waveform. In this case, the last Tm (=Tmnn) is shorter than the first Tm (=Tmn1). By setting Tmn1 to Tmnn within the range in which Math. 6 is satisfied, it is possible to weaken the parasitic vibration caused by all of the ejection waveforms in all of the pressure chambers 46.

The n-drop waveform and the drive waveform by which a number of drops other than n are ejected may be completely different waveforms. In this case, in order to maintain the printing quality, it is also necessary to reduce the difference in droplet speed ejected from the same nozzle between the n-drop waveform and the drive waveform by which a number of drops other than n are ejected. Here, it is assumed that the drive waveforms by which a number of drops other than n are ejected, which are ejected from the same nozzle, are adjusted to reduce the difference in droplet speed. Then, the time width Dpn1 (=Dpn2= . . . =Dpnn) of the n-drop waveform may be adjusted such that the speed of each droplet of the n-drop waveform or the speed of the droplet obtained by combining the droplets ejected by Dpn1 to Dpnn is close to the droplet speed of the drive waveform by which a number of drops other than n are ejected. In addition, in the drive waveform for ejecting a plurality of drops, when a passage of time after ejection is short, there are a plurality of droplets before combination. A satellite may occur after a plurality of droplets. When comparing the droplet speeds of the drive waveforms having different numbers of drops before a plurality of droplets are combined, the time width Dpn1 (=Dpn2= . . . =Dpnn) of the n-drop waveform may be adjusted so that the speed of the droplets having a largest volume (a largest droplet diameter) among the droplets ejected by the n-drop waveform and the speed of the droplets having a largest volume (a largest droplet diameter) among the droplets ejected by the drive waveform for ejecting the number of drops other than n become close (more preferably, substantially equal).

Even when it is desirable to set Dpn1 to Dpnn to different values in order to finely adjust the droplet speed of the n-drop waveform, Dpn1 to Dpnn are desirably set to values as close as possible so that the pressures of Dpn1 to Dpnn to the liquid in the pressure chamber 46 are close to each other. For example, the time difference between Dpn1, Dpn2, . . . , and Dpnn is desirably a minimum time difference other than the time difference of zero that can be set in the drive circuit 70 that generates the corresponding drive waveform.

In the example described above, the time difference (center-to-center distance) 2 UL between the adjacent ejection waveforms is set to be greater than 1.5 maxAL and smaller than 2.5 minAL in order to have a cycle in which the residual vibration of the liquid in the pressure chamber 46 generated based on the ejection waveform generated earlier and the vibration of the liquid in the pressure chamber 46 generated subsequently are increased. However, the liquid ejection head 1 is not limited to the configuration.

That is, a drive waveform including a plurality of ejection waveforms is set, and any one of the ejection waveforms after the first drop among the plurality of ejection waveforms is set as an a-th drop, and any one of the ejection waveforms after the first drop is set as a b-th drop. In this case, a time difference 2*(b−a)*UL between centers of an a-th drop ejection waveform and a b-th drop ejection waveform is set to be greater than (2*(b−a)−0.5) times a maximum value (maxAL) of the half cycle AL of the main acoustic vibration frequency of the plurality of pressure chambers 46, a volume of which is varied by the actuator 20 that inputs a drive signal, and smaller than (2*(b−a)+0.5) times a minimum value (minAL) of the half cycle AL. Accordingly, when there are two ejection waveforms or when there are three or more ejection waveforms, the time difference 2 UL between adjacent ejection waveforms is 1.5 maxAL<2 UL<2.5 minAL, as described above. In the case of a drive waveform that includes three or more ejection waveforms, the time difference 2*(b−a)*UL between two ejection waveforms that are not adjacent to each other and have one or more ejection waveforms disposed therebetween is (2*(b−a)−0.5)*maxAL<2*(b−a)*UL<(2*(b−a)+0.5)*minAL. In this way, by setting the time difference between at least any two of the plurality of ejection waveforms contained in the drive waveform to (2*(b−a)−0.5)*maxAL<2*(b−a)*UL<(2*(b−a)+0.5)*minAL, the residual vibration and the ejection waveform strengthen each other for subsequent droplets, increasing the ejection speed.

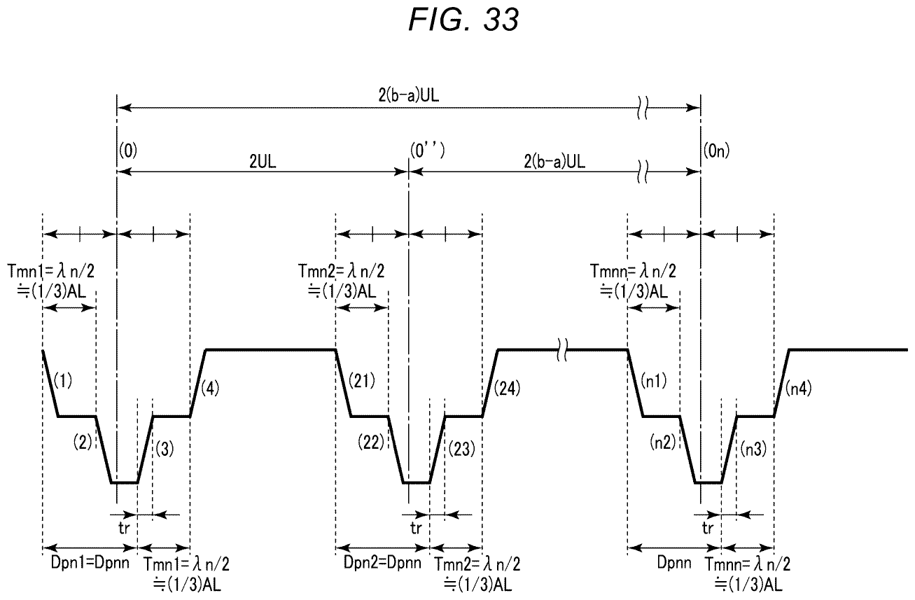

Such a liquid ejection head 1 according to another embodiment will be described with reference to FIGS. 18 and 33. FIG. 33 is a diagram showing an example of a drive waveform by which n drops of droplets are ejected as an example of the drive waveform of the liquid ejection head 1 according to another embodiment.

First, in the drive waveforms shown in FIGS. 18 and 33 by which three or more droplets are ejected, the droplets from the third drop to the n-th drop are affected by the previous ejection waveforms. A specific example will be described below.

For example, in the example of the drive waveform by which three drops of droplets are ejected as shown in FIG. 18, the droplet of the third drop is affected not only by the ejection waveform of the second drop but also by the ejection waveform of the first drop. Therefore, for example, even if the waveform by which the droplet of the second drop is ejected and the waveform by which the droplet of the third drop is ejected are in a mutually strengthening relationship, when the waveform by which the droplet of the first drop is ejected and the waveform by which the droplet of the third drop is ejected are in a weak relationship, an ejection force of the third drop is weakened by the influence of the ejection waveform of the first drop, giving rise to the concern that the speed of the third drop is not sufficiently increased and the third drop does not catch up with the preceding drop.

Therefore, in the 3-drop waveform, the waveform by which the droplet of the first drop is ejected and the waveform by which the droplet of the third drop is ejected may be made to strengthen each other. For example, as shown in FIG. 18, when the time difference between (0) and (0″) is set to be larger than 3.5 maxAL and smaller than 4.5 minAL, the phase difference between the combined wave of (1), (2), (3), and (4) and the combined wave of (31), (32), (33), and (34) is less than ±90 degrees in all of the plurality of pressure chambers 46. Accordingly, the combined wave of (1), (2), (3), and (4) and the combined wave of (31), (32), (33), and (34) strengthen each other. By setting Dp31 (=Dp32=Dp33) and adjusting the time width of Dp31 (=Dp32=Dp33), even if the half cycle AL of the main acoustic vibration frequency of the pressure chamber 46 is different from the waveform UL, the pressure applied to the liquid in the corresponding pressure chamber 46 by the ejection waveforms of the time widths of Dp31, Dp32, and Dp33 is the same. In addition, the ejection speed of the third drop ejected by the strengthening of the residual vibration due to the combined wave of (1), (2), (3), and (4) and the combined wave of (31), (32), (33), and (34) is faster than the ejection speed of the first drop.

As shown in FIG. 33, in a drive waveform (n-drop waveform) by which a plurality n droplets are continuously ejected, an ejection waveform for the a-th drop after the first drop, and an ejection waveform for the b-th drop that is 2 drops after the a-th drop and before the n-th drop are set, and the ejection waveform for the b-th drop is considered. In FIG. 33, a reference point of a phase of an n-th drop ejection waveform is denoted by (On). In such a drive waveform by which n drops of droplets are ejected, it is considered that the droplet of the b-th drop is affected by the ejection waveform of the a-th drop. When the waveform by which the droplet of the a-th drop is ejected and the waveform by which the droplet of the b-th drop is ejected are in a weak relationship, an ejection force of the b-th drop is weakened by the influence of the ejection waveform of the a-th drop, giving rise to the concern that the speed of the b-th drop is not sufficiently increased and the b-th drop does not catch up with the preceding drop. Therefore, if the reference point of the phase of the ejection waveform of the a-th drop is set to (0a), the reference point of the phase of the ejection waveform of the b-th drop, which is two drops after the ejection waveform of the a-th drop, is set to (0b), and a time difference 4 UL between (0a) and (0b) is set to be larger than 3.5*maxAL and smaller than 4.5*minAL, the residual vibrations of ejection waveform of the a-th drop and the ejection waveform of the b-th drop strengthen each other in all of the plurality of pressure chambers 46.

In a drive waveform (n-drop waveform) by which a plurality of n droplets are continuously ejected, the ejection waveform of the a-th drop after the first drop and the ejection waveform of the b-th drop after the a-th drop and before the n-th drop will be considered. In the drive waveform by which b drops or more of droplets are ejected, it is considered that the droplet of the b-th drop is affected by the ejection waveform of the a-th drop. When the waveform by which the droplet of the a-th drop is ejected and the waveform by which the droplet of the b-th drop is ejected are in a weak relationship, an ejection force of the b-th drop is weakened by the influence of the ejection waveform of the a-th drop, giving rise to the concern that the speed of the b-th drop is not sufficiently increased and the b-th drop does not catch up with the preceding drop. Therefore, if the reference point of the phase of the ejection waveform of the a-th drop is set to (0a), the reference point of the phase of the ejection waveform of the b-th drop is set to (0b), and a time difference 2*(b−a)*UL between (0a) and (0b) is set to be larger than (2*(b−a)−0.5)*maxAL and smaller than (2*(b−a)+0.5)*minAL, the residual vibrations of ejection waveform of the a-th drop and the ejection waveform of the b-th drop strengthen each other in all of the plurality of pressure chambers 46.

In this way, in the n-drop waveform by which the plurality of droplets are ejected, any one of the ejection waveforms after the first drop among the plurality of ejection waveforms is set as the a-th drop, and any one of the ejection waveforms after the a-th drop is set as the b-th drop. Then, in the liquid ejection head 1, by setting the time interval (time difference) 2*(b−a)*UL between the centers of the ejection waveform of the a-th drop and the ejection waveform of the b-th drop to (2*(b−a)−0.5)*maxAL<2*(b−a)*UL<(2*(b−a)+0.5)*minAL, the residual vibration due to the ejection waveform of the previous drop (the a-th drop) and the vibration due to the ejection waveform of the subsequent drop (the b-th drop) strengthen each other, thereby making it possible to increase the ejection speed.

The two ejection waveforms for which the time difference 2*(b−a)*UL is set as (2*(b−a)−0.5)*maxAL<2*(b−a)*UL<(2*(b−a)+0.5)*minAL may be all combinations of two ejection waveforms among the plurality of ejection waveforms of the n-drop waveform, or may be any one or more combinations of all combinations of two ejection waveforms.

Next, when there is a variation in the main acoustic vibration frequencies of the plurality of pressure chambers 46, it is considered to divide the plurality of pressure chambers 46 into a plurality of groups and adjust and input the drive waveform according to the maximum and minimum values of the half cycle AL of the main acoustic vibration frequency of each of the groups. For example, if the maximum value of the half cycle AL of the main acoustic vibration frequency of the plurality of pressure chambers 46 is 3.5 μs and the minimum value is 2.5 μs, the pressure chambers 46 with the AL of 3.5 μs or less to 3.0 μs or more are defined as a first group, and the pressure chambers 46 with the AL of 3.0 μs or less to 2.5 μs or more are defined as a second group. Here, the pressure chamber 46 that satisfies the conditions for both the first and second groups (for example, the pressure chamber 46 with the AL of 3.0 μs) is defined as belonging to either group. For example, if a group of the pressure chambers 46 that satisfies the conditions for both the first group and the second group is made the same as an adjacent group of the pressure chambers 46, management and distinction of each of the groups becomes easier.

Accordingly, maxAL of the first group of the pressure chambers 46 is 3.5 μs and minAL is 3.0 μs. The time interval (time difference) 2*(b−a)*UL between the centers of the ejection waveform of the a-th drop and the ejection waveform of the b-th drop in the n-drop waveforms input to the pressure chambers 46 of the first group is set as (2*(b−a)−0.5)*maxAL<2*(b−a)*UL<(2*(b−a)+0.5)*minAL.

The maxAL of the pressure chambers 46 in the second group is 3.0 μs, and the minAL is 2.5 μs. The time interval (time difference) 2*(b−a)*UL between the centers of the ejection waveform of the a-th drop and the ejection waveform of the b-th drop in the n-drop waveforms input to the pressure chambers 46 of the second group is set as (2*(b−a)−0.5)*maxAL<2*(b−a)*UL<(2*(b−a)+0.5)*minAL.

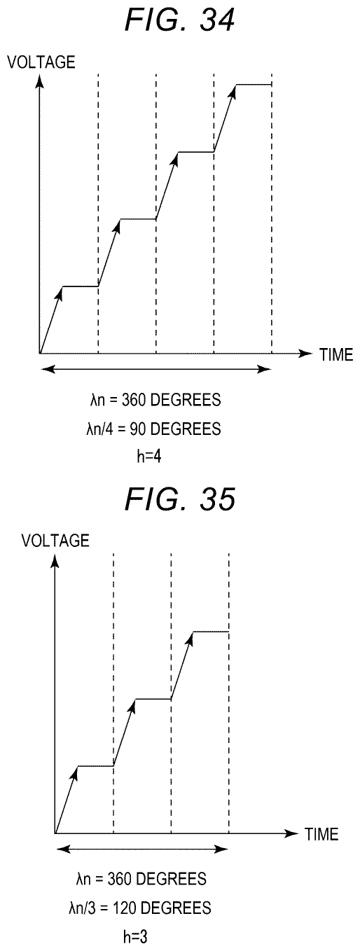

Next, in the drive waveform of the drive circuit 70, the drive waveform of the liquid ejection head 1 in which the potential difference (contraction potential difference) of the ejection waveform or the cancel waveform is continuously increased twice or more for h times will be described with reference to FIGS. 34 and 35.

First, among the drive waveforms according to another embodiment, the ejection waveform will be described. In the ejection waveform of the liquid ejection head 1, if one of first to (h−1)-th potential difference changes is set as an i-th potential difference change, one of (i+1)-th to h-th potential difference changes is set as a j-th potential difference change, and a time interval between the i-th and j-th potential difference change start times is set as Tij, any one of the time intervals Tij is
(k/2−1/6)λn≤Tij≤(k/2+1/6)λn . . . (Math. 7). Here, k is an odd number of 1 or more.

According to the ejection waveform that satisfies Math. 7, a parasitic vibration with the cycle λn generated by the corresponding two or more potential difference changes is weakened, and the parasitic vibration with the cycle λn generated in the pressure chamber 46 can be reduced. The same applies to a case in which the pressure chamber 46 is expanded h times, which is 2 or more.

Further, when i+1=j, that is, when Tij is the time interval between continuous potential difference changes, taking into consideration reduction in power consumption, it is desirable that the time interval Tij is
(k/2−1/6)λn≤Tij≤kλn/2 . . . (Math. 8). Here, k is an odd number of 1 or more.

In the ejection waveform, when there is another potential difference change in which the time interval Tij satisfies (k/2−1/6)λn≤Tij≤(k/2+1/6)λn (k is an odd number of 1 or more) or satisfies (k/2−1/6)λn≤Tij≤kλn/2 (k is an odd number of 1 or more) in all the potential difference changes from the first time to the h-th time, it is possible to further reduce the parasitic vibration of the cycle λn generated in the pressure chamber 46.

In addition, by making potential difference change amounts of the i-th and j-th potential difference changes at the time interval Tij satisfying (k/2−1/6)λn≤Tij≤(k/2+1/6)λn (k is an odd number of 1 or more) the same, it is possible to further reduce the residual vibration derived from the parasitic vibration thereafter. More preferably, since an optimum holding time for each stage when it is assumed that the potential difference for each stage is the same and the pressure vibration is not attenuated is set to λn/number of stages (h), the time interval Tij for all of the continuous potential difference changes may be set to λn/number of stages (h).

From the viewpoint of reducing the power consumption by strengthening the main sound vibration, in the ejection waveform, when the number of potential difference changes in which the pressure chamber 46 is continuously expanded is two or more times, which is h times, it is desirable that the time interval Tij between times of the first potential difference change and the h-th potential difference change is within 0.5 times the half cycle AL of the main acoustic vibration. This is because, by setting the time interval Tij between the first potential difference change and the h-th potential difference change to be within 0.5 times the half cycle AL of the main acoustic vibration, the main acoustic vibration generated in all of the potential difference changes from the first time to the h-th time is strengthened, which contributes to a reduction in power consumption.

As an example of the ejection waveform described above, FIG. 34 shows an example in which the number of stages (number of times) of the rising waveform is four (four times), and FIG. 35 shows an example in which the number of stages of the rising waveform is three. In FIG. 34, each number of stage h is shown in parentheses. The same applies to the falling waveform. As shown in FIGS. 34 and 35, when it is assumed that the potential differences of each of the stages are the same and the pressure vibration is not attenuated, the optimum holding time of each stage is λn/number of stages (h). Therefore, when any two phase differences (time intervals) among potential difference displacements from the first stage to the h-th stage are in the range from (k/2−1/6)λn to (k/2+1/6) an, the parasitic vibration generated in the two potential difference displacements is weakened. For example, the time interval between the first and third potential difference displacements in FIG. 34 is λn/2, and Tij in the case of i=1 and j=3 satisfies Math. 7. In addition, the time interval between the second and fourth potential difference displacements in FIG. 34 is λn/2, and Tij in the case of i=2 and j=4 also satisfies Math. 7. Therefore, the parasitic vibration is weakened.

The pressure vibration in the pressure chamber 46 is attenuated with the passage of time due to a viscous resistance of an ink. Further, normally, the parasitic vibration is attenuated more rapidly with the passage of time than the main acoustic vibration. Therefore, the potential difference change from 0.5AL before ejection to immediately after ejection has a greater effect on the satellite and printing quality than the potential difference change in the time range from 1.5AL before ejection to 0.5AL before ejection, and the potential difference change from 1.5AL before ejection to 0.5AL before ejection (the range in which the main acoustic vibrations described above strengthen each other) has a greater effect on the satellite and printing quality than the potential difference change in the time range before 1.5AL. Therefore, in the ejection waveform, it is desirable to adjust the value of Tm or Tij to satisfy the condition that the parasitic vibration is weakened with respect to Tm or Tij closer to immediately before and after ejection among the time intervals of any two times of the potential difference changes.

In the liquid ejection head 1, the cycles λn of the parasitic vibrations of the plurality of pressure chambers 46 may not be the same due to manufacturing variations. Here, a maximum value of the cycles λn of the parasitic vibrations of the plurality of pressure chambers 46 is maxλn, and a minimum value is minλn. In this case, in the plurality of pressure chambers 46, a lower limit of Math. 7 is largest when it is (k/2−1/6)maxλn, and an upper limit of Math. 7 is smallest when it is (k/2+1/6)minλn. Therefore,
(k/2−1/6) maxλn≤Tm≤(k/2+1/6) minλn . . . (Math. 9) is obtained. Here, k is an odd number of 1 or more.

When Tij is set within a range in which Math. 9 is satisfied, the parasitic vibration can be weakened in all of the plurality of pressure chambers 46.

According to the liquid ejection head 1 according to the plurality of embodiments described above, the time width of the preceding ejection waveform and the time width of the subsequent ejection waveform are set to be the same (including substantially the same), and the interval between the ejection waveforms is set to be the same as the cycle in which the residual vibration of the liquid in the pressure chamber generated by the ejection waveform generated earlier and the vibration of the liquid in the pressure chamber generated by the ejection waveform generated subsequently are strengthened. That is, the drive waveform has substantially the same ejection waveform width when continuously ejecting the plurality of droplets, and the center-to-center distance 2*(b−a)*UL of two ejection waveforms among the plurality of ejection waveforms when continuously ejecting the plurality of droplets is set to (2*(b−a)−0.5)*maxAL<2*(b−a)*UL<(2*(b−a)+0.5)*minAL. The liquid ejection head can make the ejection force of each droplet substantially the same and increase the ejection speed of the subsequent droplet. Since the ejection waveform widths are substantially the same, the ejection forces of the droplets according to the respective ejection waveforms are substantially the same, and since the center-to-center distance 2*(b−a)*UL of two ejection waveforms among the plurality of ejection waveforms is set to 2*(b−a)−0.5)*maxAL<2*(b−a)*UL<(2*(b−a)+0.5)*minAL, the residual vibration and the ejection waveform of the subsequent droplet strengthen each other and the ejection speed increases. The printing quality of the liquid ejection head is improved by the cancellation of the parasitic vibration.

In addition, the liquid ejection head 1 can adjust the ejection waveform width when the number of continuously ejection droplets is large so that the speed is substantially the same regardless of the number of droplets. The liquid ejection head 1 cancels out the parasitic vibration by setting an intermediate voltage time to around a half cycle of the parasitic vibration. In addition, the intermediate voltage time of the ejection waveform by which a last droplet is ejected can be made shorter than the intermediate voltage time of the ejection waveform before that.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection head comprising:
a nozzle plate including a nozzle;
a pressure chamber that is capable of storing liquid and communicates with the nozzle, a volume of the pressure chamber being varied to eject the liquid from the nozzle;
an actuator configured to vary the volume of the pressure chamber in response to a drive signal; and
a drive circuit configured to generate the drive signal, wherein
the drive signal includes a plurality of ejection waveforms, each including:
a plurality of expansion waveforms for applying voltages to expand the volume of the pressure chamber, and
a plurality of contraction waveforms for apffplying voltages to contract the volume of the pressure chamber, and
one of the expansion waveforms and one of the contraction waveforms respectively cancel out vibrations of an acoustic resonance frequency higher than a main acoustic resonance frequency of the liquid in the pressure chamber, the vibrations being caused by a preceding one of the expansion waveforms, which is followed by said one of the expansion waveforms, and a preceding one of the contraction waveforms, which is followed by said one of the contraction waveforms.

2. The liquid ejection head according to claim 1, wherein
when a total number of voltage changes applied by the drive signal is h, one of first to (h−1)-th voltage changes is defined as an i-th voltage change, and one of (i+1)-th to h-th voltage changes is defined as a j-th voltage change, a time interval Tij between the i-th and j-th voltage changes satisfies:
$$( k / 2 - 1 / 6 ) λ n \leq Tij \leq ( k / 2 + 1 / 6 ) λ n ,$$
where k is an odd number of 1 or more, and λn is a cycle of the acoustic resonance frequency higher than the main acoustic resonance frequency.

3. The liquid ejection head according to claim 2, wherein
the time interval Tij satisfies:
$$( k / 2 - 1 / 6 ) λ n \leq Tij \leq k λ n / 2 ,$$
where k is an odd number of 1 or more.

4. The liquid ejection head according to claim 1, wherein
the drive circuit includes a switching circuit connected to a plurality of voltage sources corresponding to the voltages applied by the drive signal that includes the expansion and contraction waveforms.

5. The liquid ejection head according to claim 1, wherein
an interval between centers of two adjacent ejection waveforms is greater than 1.5 half-cycles of the main acoustic resonance frequency and less than 2.5 half-cycles of the main acoustic resonance frequency.

6. The liquid ejection head according to claim 5, wherein
the interval between the centers of two adjacent ejection waveforms is substantially 2 half-cycles of the main acoustic resonance frequency.

7. The liquid ejection head according to claim 1, wherein
the acoustic resonance frequency higher than the main acoustic resonance frequency is approximately an odd multiple of the main acoustic resonance frequency.

8. The liquid ejection head according to claim 1, wherein
when one of the plurality of ejection waveforms corresponds to an a-th drop and another one of the ejection waveforms after the a-th drop corresponds to a b-th drop, a time interval between centers of the ejection waveforms of the a-th and b-th drops is larger than (2*(b−a)−0.5) times a maximum value of a half cycle of the main acoustic resonance frequency, and is smaller than (2*(b−a)+0.5) times a minimum value of the half cycle.

9. The liquid ejection head according to claim 1, wherein
a time interval of an intermediate potential difference of any ejection waveform among the plurality of ejection waveforms is equal to or more than a time interval of an intermediate potential difference of a next ejection waveform of the any ejection waveform.

10. A liquid ejection apparatus comprising:
a plurality of rollers for conveying a print medium; and
a liquid ejection head configured to eject liquid onto the conveyed medium and including:
a nozzle plate including a nozzle,
a pressure chamber that is capable of storing liquid and communicates with the nozzle, a volume of the pressure chamber being varied to eject the liquid from the nozzle,
an actuator configured to vary the volume of the pressure chamber in response to a drive signal, and
a drive circuit configured to generate the drive signal, wherein
the drive signal includes a plurality of ejection waveforms, each including:
a plurality of expansion waveforms for applying voltages to expand the volume of the pressure chamber, and
a plurality of contraction waveforms for applying voltages to contract the volume of the pressure chamber, and
one of the expansion waveforms and one of the contraction waveforms respectively cancel out vibrations of an acoustic resonance frequency higher than a main acoustic resonance frequency of the liquid in the pressure chamber, the vibrations being caused by a preceding one of the expansion waveforms, which is followed by said one of the expansion waveforms, and a preceding one of the contraction waveforms, which is followed by said one of the contraction waveforms.

11. The liquid ejection apparatus according to claim 10, wherein
when a total number of voltage changes applied by the drive signal is h, one of first to (h−1)-th voltage changes is defined as an i-th voltage change, and one of (i+1)-th to h-th voltage changes is defined as a j-th voltage change, a time interval Tij between the i-th and j-th voltage changes satisfies:
$$( k / 2 - 1 / 6 ) λ n \leq Tij \leq ( k / 2 + 1 / 6 ) λ n ,$$
where k is an odd number of 1 or more, and λn is a cycle of the acoustic resonance frequency higher than the main acoustic resonance frequency.

12. The liquid ejection apparatus according to claim 11, wherein
the time interval Tij satisfies:
$$( k / 2 - 1 / 6 ) λ n \leq Tij \leq k λ n / 2 ,$$
where k is an odd number of 1 or more.

13. The liquid ejection apparatus according to claim 10, wherein
the drive circuit includes a switching circuit connected to a plurality of voltage sources corresponding to the voltages applied by the drive signal that includes the expansion and contraction waveforms.

14. The liquid ejection apparatus according to claim 10, wherein
an interval between centers of two adjacent ejection waveforms is greater than 1.5 half-cycles of the main acoustic resonance frequency and less than 2.5 half-cycles of the main acoustic resonance frequency.

15. The liquid ejection apparatus according to claim 14, wherein
the interval between the centers of two adjacent ejection waveforms is substantially 2 half-cycles of the main acoustic resonance frequency.

16. The liquid ejection apparatus according to claim 10, wherein
the acoustic resonance frequency higher than the main acoustic resonance frequency is approximately an odd multiple of the main acoustic resonance frequency.

17. The liquid ejection apparatus according to claim 10, wherein
when one of the plurality of ejection waveforms corresponds to an a-th drop and another one of the ejection waveforms after the a-th drop corresponds to a b-th drop, a time interval between centers of the ejection waveforms of the a-th and b-th drops is larger than (2*(b−a)−0.5) times a maximum value of a half cycle of the main acoustic resonance frequency, and is smaller than (2*(b−a)+0.5) times a minimum value of the half cycle.

18. The liquid ejection apparatus according to claim 10, wherein
a time interval of an intermediate potential difference of any ejection waveform among the plurality of ejection waveforms is equal to or more than a time interval of an intermediate potential difference of a next ejection waveform of the any ejection waveform.
